(19) United States
(12) Patent Application Publication
(10) Pub. No.: US 2022/0164150 A1
(43) Pub. Date: May 26, 2022

(54) PRINT CONTROL APPARATUS, PRINT CONTROL METHOD, AND STORAGE MEDIUM STORING PRINT CONTROL PROGRAM

(71) Applicant: CANON KABUSHIKI KAISHA, Tokyo (JP)

(72) Inventor: Ryo Fujita, Tokyo (JP)

(21) Appl. No.: 17/527,492

(22) Filed: Nov. 16, 2021

(30) Foreign Application Priority Data
Nov. 24, 2020 (JP) 2020-194479

(51) Int. Cl. G06F 3/12

(52) U.S. Cl. CPC G06F 3/1259; G06F 3/1286; G06F 3/1207

(57) ABSTRACT

A print control apparatus that is capable of reducing occurrence of an error in a verification result of a printed sheet even if an unexpected job occurs. The print control apparatus includes a determination unit and a controller. The determination unit determines whether a verification apparatus verifies a printed sheet that is printed according to a second job in a case where a print instruction of a first job that is different from the second job is received. The controller controls to switch the print instruction of the first job to another job operation in the print control apparatus in a case where the determination unit determines that the verification apparatus verifies the printed sheet that is printed according to the second job.

### BACKGROUND OF THE INVENTION

### Field of the Invention

The present invention relates to a print control apparatus, a print control method, and a storage medium storing a print control program.

### Description of the Related Art

There is a verification apparatus that reads a printed sheet that is printed by a printing apparatus like a multifunction apparatus to verify quality of the printed sheet on the basis of a reading result. The verification apparatus detects print omission, an error of characters, and quality of a bar code on a printed sheet. The verification apparatus verifies a printed sheet by comparing correct answer data of a print job input into the printing apparatus with image data that is obtained by reading the printed sheet. When the correct answer data and the image data coincide, a verification result becomes a normal product. When they do not coincide, the verification result becomes a defective product.

In the meantime, the printing apparatus can process a plurality of print jobs received from an external apparatus. The external apparatus transmits a print job of a printing target to the printing apparatus from among a plurality of print jobs currently held on the basis of a user's instruction. Then, the external apparatus transmits the plurality of print jobs to the printing apparatus in a predetermined print order on the basis of a print instruction from a user. At this time, when an unexpected print job is input into the printing apparatus, the printing apparatus may not print in a correct print order.

Japanese Laid-Open Patent Publication (Kokai) No. 2014-106826 (JP 2014-106826A) suggests a related technique. The technique generates an output order list that records pieces of identification information about print processes in a reception order of print instructions. The technique temporarily accumulates output data about the received print instructions and generates a print order list that records pieces of identification information about the print processes in a transmission order to an image forming apparatus. Then, the verification is performed by comparing the pieces of identification information recorded in the two lists in order from heads of the lists.

For example, a print system in which a printing apparatus and a verification apparatus are connected may be used. In the print system concerned, when a print job is transmitted to the printing apparatus from an external apparatus, a printed sheet that is printed by the printing apparatus is conveyed to the verification apparatus. Then, the verification apparatus reads an image of the printed sheet and verifies the printed sheet by comparing correct answer data of the print job with the read image. At this time, an unexpected job may be input into the printing apparatus while the printing apparatus is processing the print job for verification. In such a case, when an unexpected job is input into the printing apparatus, the corresponding relation between the order of the printed sheet that is printed by the printing apparatus and the order of the correct answer data becomes inconsistent, even if the lists are used as the technique of the above-mentioned publication. As a result, an error occurs in the verification result of the printed sheet. This problem may occur also in a system other than the print system in which a printing apparatus and a verification apparatus are connected.

### SUMMARY OF THE INVENTION

The present invention provides a print control apparatus, a print control method, and a storage medium storing a print control program, which are capable of reducing occurrence of an error in a verification result of a printed sheet even if an unexpected job occurs.

Accordingly, an aspect of the present invention provides a print control apparatus including a determination unit configured to determine whether a verification apparatus verifies a printed sheet that is printed according to a second job in a case where a print instruction of a first job that is different from the second job is received, and a controller configured to control to switch the print instruction of the first job to another job operation in the print control apparatus in a case where the determination unit determines that the verification apparatus verifies the printed sheet that is printed according to the second job.

According to the present invention, occurrence of an error in a verification result of a printed sheet is reduced even if an unexpected job occurs.

Further features of the present invention will become apparent from the following description of exemplary embodiments with reference to the attached drawings.

### BRIEF DESCRIPTION OF THE DRAWINGS

FIG. 1 is a view showing an example of a hardware configuration of an image processing system according to an embodiment of the present invention.

FIG. 2 is a block diagram showing examples of hardware configurations of apparatuses in the image processing system.

FIG. 3 is a sectional view showing an image forming apparatus in the image processing system.

FIG. 4 is a view showing an example of a screen displayed when a verification apparatus in the image forming apparatus is started.

FIG. 5 is a view showing an example of a screen displayed on an operation unit of the verification apparatus when a correct answer image is registered.

FIG. 6 is a view showing an example of a screen displayed on the operation unit of the verification apparatus when the correct answer image is being read.

FIG. 7 is a view showing an example of a screen displayed on the operation unit of the verification apparatus after completing reading of the correct answer image.

FIG. 8 is a view showing an example of a setting screen of a verification skip area displayed on the operation unit of the verification apparatus.

FIG. 9 is a view showing an example of a screen displayed on the operation unit of the verification apparatus when verification parameters are set up.

FIG. 10 is a view showing an example of a screen that shows a verification result and is displayed on the operation unit of the verification apparatus.

FIG. 11 is a view showing an example of a screen displayed on the operation unit of the verification apparatus after starting verification.

FIG. 12 is a view showing another example of a screen displayed on the operation unit of the verification apparatus after starting the verification.

FIG. 13 is a flowchart showing an example of a flow of a process that is executed when the verification apparatus registers a correct answer image.

FIG. 14 is a flowchart showing an example of a flow of a verification process that the verification apparatus executes.

FIG. 15 is a view showing an example of a print setting screen for a job displayed on a display unit of an external controller in the image processing system.

FIG. 16 is a view showing examples of outputs of a job.

FIG. 17 is a flowchart showing an example of a flow of a process that is executed when a print instruction is issued to the external controller.

FIG. 18A, FIG. 18B, and FIG. 18C are views showing examples of a job management screen displayed on the display unit of the external controller.

FIG. 19 is a flowchart showing an example of a flow of a job control process executed by the external controller.

FIG. 20 is a view showing an example of a warning dialog that is superimposed and displayed on the screens in FIG. 18A, FIG. 18B, and FIG. 18C.

### DESCRIPTION OF THE EMBODIMENTS

Hereafter, embodiments according to the present invention will be described in detail by referring to the drawings. However, the configurations described in the following embodiments are mere example. And the scope of the present invention is not limited to the configurations described in the following embodiments.

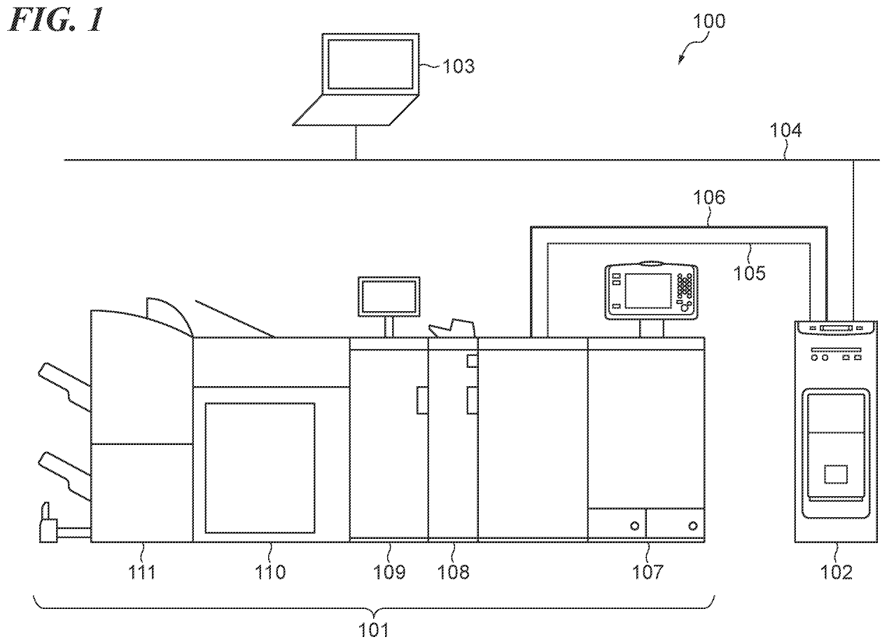

FIG. 1 is a view showing an example of a hardware configuration of an image processing system 100 according to this embodiment. The image processing system 100 includes an image forming apparatus 101, an external controller 102, and a client terminal 103. The image forming apparatus 101 and the external controller 102 are connected through an internal LAN 105 and a video cable 106 so as to be mutually communicable. The external controller 102 is connected with the client terminal 103 through an external LAN 104 so as to be mutually communicable. The external controller 102 is a print control apparatus that issues a print instruction to the client terminal 103. The connection between the image forming apparatus 101 and external controller 102 and the connection between the external controller 102 and client terminal 103 may be wired connection and may be wireless connection.

The client terminal 103 is a personal computer, for example. A printer driver that has a function that converts print data into print description language that can be processed by the external controller 102 is installed into the client terminal 103. A user can issue a print instruction from various applications installed in the client terminal 103 through the printer driver. The client terminal 103 transmits print data to the external controller 102 through the printer driver in response to a print instruction from a user. When receiving the print instruction from the client terminal 103, the external controller 102 executes various processes, such as a data analysis process and a rasterizing process and inputs a job including print data to the image forming apparatus 101.

The image forming apparatus 101 will be described. The image forming apparatus 101 includes a plurality of apparatuses that respectively have different functions and are connected. The image forming apparatus 101 is constituted so that complicated print processes, such as a bookbinding process, can be executed. In the example in FIG. 1, the image forming apparatus 101 as a print system includes a printer 107, an inserter 108, a verification apparatus 109, a large-capacity stacker 110, and a finisher 111.

The printer 107 forms an image using toner on a sheet conveyed from a sheet cassette provided in a lower part of the printer 107. The printer 107 irradiates a photosensitive drum with a scanning light beam like a laser beam that is modulated according to image data and is reflected by a polygon mirror. An electrostatic latent image formed on the photosensitive drum with the laser beam is developed by toner, and a toner image is transferred to a sheet pasted on a transfer drum. A full color image is formed on a sheet by sequentially executing a series of image forming processes with toners of yellow (Y), magenta (M), cyan (C), and black (K). It should be noted that the printer 107 may be an apparatus that forms a monochrome image. The sheet on the transfer drum on which the image is formed is conveyed to a fixing device. The fixing device includes rollers and a belt, and a roller contains a heat source like a halogen heater. Then, the fixing device melts the toner on the sheet on which the toner image is transferred with heat and pressure and fixes the toner image to the sheet.

The inserter 108 is an apparatus for inserting a sheet. The inserter 108 can insert a sheet in arbitrary positions to a sheet group printed and conveyed with the printer 107. The verification apparatus 109 reads an image of a conveyed sheet and performs verification to determine whether the sheet on which the image is printed is a normal product or a defective product by comparing the read image with a correct answer image registered beforehand. The large-capacity stacker 110 is a stacker that can stack mass sheets. The finisher 111 is an apparatus that applies finishing processes to a conveyed sheet. There are a stapling process, a punching process, a saddle stitch bookbinding process, etc. as the finishing processes. The finisher 111 discharges a sheet to which a finishing process is applied to a discharge tray.

Since the image forming apparatus 101 is designed so that a sheet verified by the verification apparatus 109 will be stacked in the large-capacity stacker 110, the large-capacity stacker 110 is connected to a downstream side of the verification apparatus 109 in a connecting relation shown in FIG. 1. However, the connecting relation of the verification apparatus 109 and the large-capacity stacker 110 is not limited to the example shown in FIG. 1. For example, the large-capacity stacker 110 or another sheet stacking device may be connected to an upstream side of the verification apparatus 109 in order to stack sheets that are not verified. This point is mentioned later. Moreover, sheet stacking devices may be respectively connected to both the upstream side and the downstream side of the verification apparatus 109.

The configuration of the image forming apparatus 101 may not be limited to the example shown in FIG. 1. For example, another apparatus may be added and some apparatus may be omitted. The image forming apparatus 101 may be connected to the client terminal 103 through the external LAN 104 without passing the external controller 102. In this case, the client terminal 103 achieves the function of the external controller 102. When the client terminal 103 transmits print data that can be processed by the image forming apparatus 101 and the image forming apparatus 101 applies a data analysis process and a rasterizing process, the print process is executed. The client terminal 103 achieves various kinds of functions, such as reception of a print start instruction from a user and a data management of a plurality of print data that will be transmitted to the image forming apparatus 101.

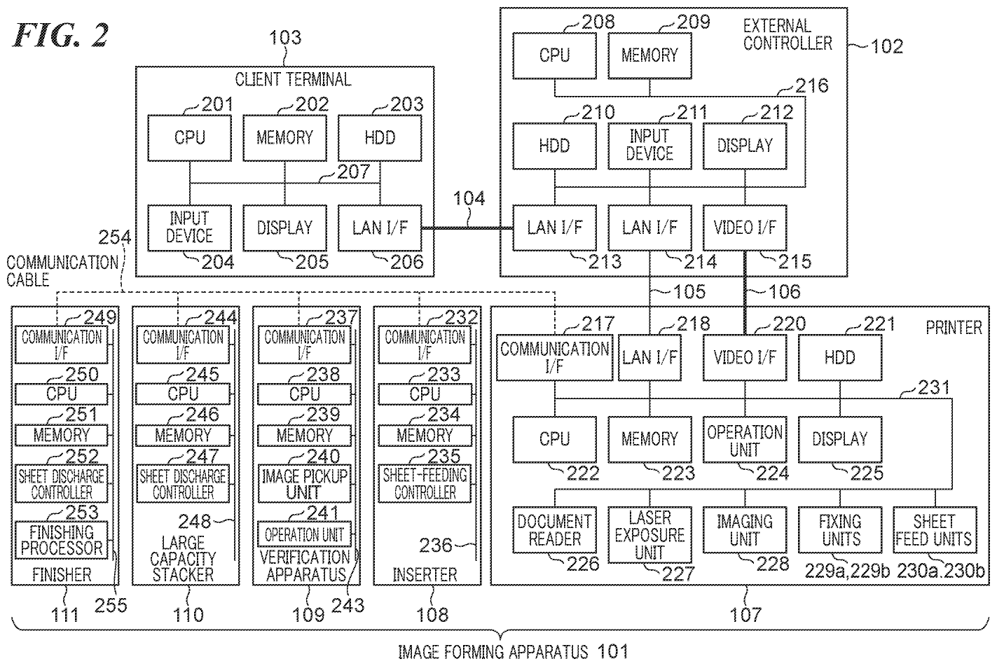

FIG. 2 is a block diagram showing examples of hardware configurations of the apparatuses in the image processing system 100. The printer 107 of the image forming apparatus 101 has a communication I/F (interface) 217, a LAN I/F 218, a video I/F 220, an HDD 221, a CPU 222, a memory 223, an operation unit 224, and a display unit 225. Moreover, the printer 107 has the document reader 226, a laser exposure unit 227, an imaging unit 228, a first fixing unit 229a, a second fixing unit 229b, a first sheet feed unit 230a, and a second sheet feed unit 230b. These units are connected through a system bus 231. The communication I/F 217 is connected with the inserter 108, the verification apparatus 109, the large-capacity stacker 110, and the finisher 111 through a communication cable 254. Control signals are communicated through the communication I/F 217. The LAN I/F 218 is connected with the external controller 102 through the internal LAN 105. Various data are communicated through the LAN I/F 218.

The video I/F 220 is connected with the external controller 102 through the video cable 106. Image data etc. are communicated through the video I/F 220. The HDD 221 is a storage unit that stores programs and data. The CPU 222 is a processor that performs various processes, such as image processing control and print control, by running programs stored in the HDD 221. The memory 223 memorizes programs, which are executed by the CPU 222 when performing various processes, image data, etc. and functions as a work area. The function of the printer 107 is achieved because the CPU 222 runs the program developed to the memory 223.

The operation unit 224 receives inputs about various setting items and instructions of operations from a user. The display unit 225 displays setting information about the image forming apparatus 101, a processing status of a job (print job), etc. The operation unit 224 and the display unit 225 may be integrally constituted as a touch panel display unit. The document reader 226 performs a document reading process when using a copy function and a scan function. The document reader 226 reads document data by capturing an image with a CCD sensor while illuminating a document placed by a user with an exposure lamp. The laser exposure unit 227 performs primary charge, laser exposure for irradiating a photosensitive drum with a laser beam, etc. in order to transfer a toner image. The laser exposure unit 227 first performs the primary charge that electrifies a photosensitive drum surface to uniform negative potential. Next, a laser beam from a laser driver is deflected by the polygon mirror so as to illuminate the photosensitive drum. Thereby, the minus electric charge of an irradiated portion is neutralized and an electrostatic latent image is formed.

The imaging unit 228 is a device for transferring toner to a sheet. The imaging unit 228 has a development unit, a transfer unit, a toner supply unit, etc., and transfers the toner on the photosensitive drum to the sheet. The development unit sticks the toner electrified in minus to the electrostatic latent image on the photosensitive drum surface from a development cylinder to visualize the image. The transfer unit applies positive potential to a primary transfer roller and performs primary transfer that transfers the toner on the photosensitive drum surface to a transfer belt. Moreover, the transfer unit applies positive potential to a secondary transfer outer roller and performs secondary transfer that transfers the toner on the transfer belt to a sheet. Each of the fixing units 229a and 229b melts and fixes the toner on the sheet with heat and pressure. Each of the fixing units 229a and 229b has a heat roller including a heater, a pressure roller, etc. The sheet feed units 230a and 230b are devices for feeding a sheet. A feeding operation and conveyance operation of a sheet are achieved by rollers on the basis of outputs of various sensors.

The inserter 108 of the image forming apparatus 101 has a communication I/F 232, a CPU 233, a memory 234, and a sheet-feeding controller 235, and these units are connected through a system bus 236. The communication I/F 232 is connected with the printer 107 through the communication cable 254. Control signals are communicated through the communication I/F 232. The CPU 233 performs various control processes required for feeding a sheet according to control programs stored in the memory 234. The memory 234 is a storage unit that stores the control programs. The sheet-feeding controller 235 controls feeding and conveyance of a sheet conveyed from the sheet feed unit of the inserter 108 or the printer 107 on the basis of instructions from the CPU 233.

The verification apparatus 109 of the image forming apparatus 101 has a communication I/F 237, a CPU 238, a memory 239, an image pickup unit 240, and an operation unit 241, and these units are connected through a system bus 243. The verification apparatus 109 verifies a printed sheet that is a sheet on which an image is formed. The communication I/F 237 is communicable with the other devices of the image forming apparatus 101 through the communication cable 254. Control signals are communicated through the communication I/F 237. The CPU 238 performs various control processes of this embodiment required for verification according to control programs stored in the memory 239. The memory 239 is a storage unit that stores the control programs. The image pickup unit 240 captures the conveyed sheet on the basis of an instruction from the CPU 238. The conveyed sheet is the printed sheet that is printed by the printer 107. The CPU 238 compares the image that is captured by the image pickup unit 240 with the correct answer image stored in the memory 239 to determine whether the image of the printed sheet is normal. The CPU 238 verifies the printed sheet on the basis of the determination result. The operation unit 241 has an operational function and a display function. The operation unit 241 receives an operation from a user and displays information about a verification result, a setting screen, etc. User's operations include an instruction to change setting values of the verification apparatus 109 and an instruction to register a correct answer image, for example. The operation unit 241 is a touch panel display unit, for example. However, the verification apparatus 109 may provide the above-mentioned operational function and display function as separate devices.

The large-capacity stacker 110 of the image forming apparatus 101 has a communication I/F 244, a CPU 245, a memory 246, and a sheet discharge controller 247, and these units are connected through a system bus 248. The communication I/F 244 is connected with the printer 107 through the communication cable 254. Control signals are communicated through the communication I/F 244. The CPU 245 performs various control processes required for discharging a sheet according to control programs stored in the memory 246. The memory 246 is a storage unit that stores the control programs. The sheet discharge controller 247 controls to convey the conveyed sheet to a stack tray, an escape tray, or the following finisher 111 according to an instruction from the CPU 245.

The finisher 111 of the image forming apparatus 101 has a communication I/F 249, a CPU 250, a memory 251, a sheet discharge controller 252, and a finishing processor 253, and these units are connected through a system bus 255. The communication I/F 249 is connected with the printer 107 through the communication cable 254. Control signals are communicated through the communication I/F 249. The CPU 250 performs various control processes required for finishing or discharging a sheet according to control programs stored in the memory 246. The memory 251 is a storage unit that stores the control programs. The sheet discharge controller 252 controls conveyance and discharge of a sheet according to an instruction from the CPU 250. The finishing processor 253 controls the finishing processes, such as the stapling process, punching process, and saddle stitch bookbinding process, according to an instruction from the CPU 250.

The external controller 102 will be described. The external controller 102 has a CPU 208, a memory 209, an HDD 210, an input device 211, a display unit 212, a LAN I/F 213, a LAN I/F 214, and a video I/F 215. These units of the external controller 102 are connected through a system bus 216. The external controller 102 corresponds to the print control apparatus. In the meantime, when the client terminal 103 achieves the function of the external controller 102, the client terminal 103 corresponds to the print control apparatus.

The CPU 208 comprehensively executes processes, such as reception of print data from the client terminal 103, an RIP process, and transmission of print data to the image forming apparatus 101, on the basis of the programs and data that are stored in the HDD 210. The memory 209 memorizes programs and data that are needed when the CPU 208 performs various processes, and functions as a work area. Each process of the external controller 102 in this embodiment is achieved because the CPU 208 runs the program developed to the memory 209. The external controller 102 may have a plurality of CPUs. Moreover, the CPU 208 may perform the processes of this embodiment by executing the processes in parallel. The CPU 208 corresponds to a determination unit and a control unit.

The HDD 210 stores programs and data that are required for operations of a print process etc. The input device 211 is a device for inputting an operation instruction of the external controller 102. The input device 211 can employ a keyboard, a mouse, etc. Information about the executing application of the external controller 102 is displayed on the display unit 212 using a video signal of a static image or a moving image. The input device 211 and the display unit 212 may be integrally constituted as a touch panel display unit. The LAN I/F 213 is connected with the client terminal 103 through the external LAN 104 and manages communications like a print instruction etc. The LAN I/F 214 is connected with the image forming apparatus 101 through the internal LAN 105 and manages communications like a print instruction etc. The video I/F 215 is connected with the image forming apparatus 101 through the video cable 106 and manages various communications.

The client terminal 103 will be described. The client terminal 103 has a CPU 201, a memory 202, an HDD 203, an input device 204, a display unit 205, and a LAN I/F 206, and these units are connected through a system bus 207. The CPU 201 generates print data and issues a print instruction according to a document processing program etc. that are stored in the HDD 203. The CPU 201 comprehensively controls the units connected to the system bus 207. The memory 202 memorizes programs and data that are needed when the CPU 201 performs various processes, and functions as a work area. The HDD 203 stores programs and data that are required for operations of a print process etc. The input device 204 is a device for inputting an operation instruction of the client terminal 103. The input device 204 can employ a keyboard, a mouse, etc. Information about the executing application of the client terminal 103 is displayed on the display unit 205 using a video signal of a static image or a moving image. The input device 204 and the display unit 205 may be integrally constituted as a touch panel display unit. The LAN I/F 206 is connected with the external LAN 104 and manages various communications.

Although the external controller 102 and the image forming apparatus 101 are connected through the internal LAN 105 and video cable 106 in the example in FIG. 2, the connections between them are not limited to the example in FIG. 2 as long as data for executing a print job can be transmitted and received. For example, when data for executing a print job can be transmitted and received through the video cable 106, the internal LAN 105 may not be connected between the external controller 102 and the image forming apparatus 101. Moreover, the memories 202, 209, 223, 234, 239, 246, and 251 of the respective devices can be achieved by arbitrary devices as long as they can memorize data and programs. For example, each memory may employ a volatile RAM, a nonvolatile ROM, a built-in HDD, an external HDD, a USB memory, or the like.

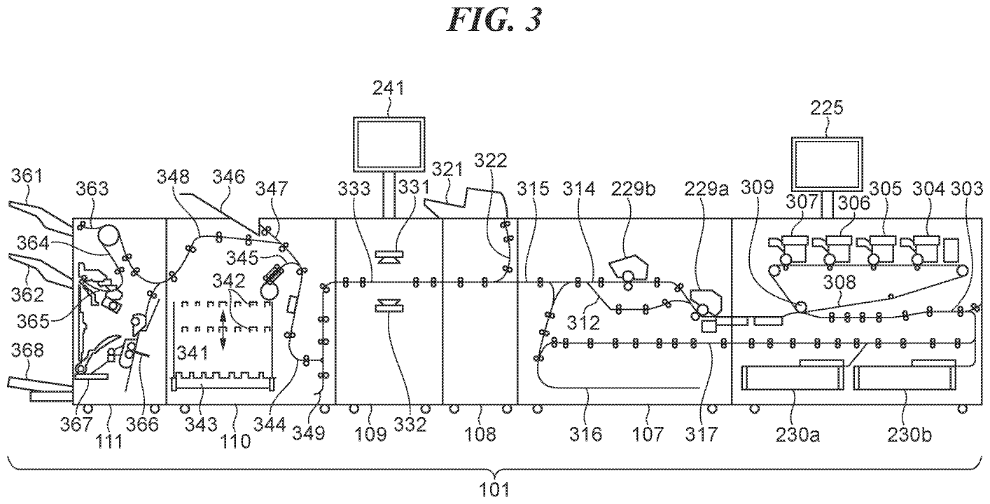

Next, the configuration of the image forming apparatus 101 will be described. FIG. 3 is a sectional view showing the image forming apparatus 101. The printer 107 has the first and second sheet feed units (feed decks) 230a and 230b. The sheet feed units 230a and 230b can store various kinds of sheets. Each of the sheet feed units 230a and 230b can separate a topmost sheet of stored sheets and convey the separated sheet to the sheet conveyance path 303. Development stations 304, 305, 306, and 307 respectively form toner images using color toners of Y, M, C, and K. The formed toner images are primarily transferred to the intermediate transfer belt 308 in an overlapped fashion so as to form a color image. The intermediate transfer belt 308 rotates clockwise. Then, the color toner image is transferred to the sheet conveyed through the sheet conveyance path 303 at a secondary transfer position 309.

The display unit 225 displays information about a printing status and settings of the image forming apparatus 101. The first fixing unit 229a fixes the toner image to the sheet. The first fixing unit 229a has the pressure roller and the heat roller. When the sheet passes between the rollers, the toner image is fixed to the sheet by melting and pressuring the toner. The sheet that passes through the first fixing unit 229a is conveyed through a sheet conveyance path 312 to a conveyance path 315. Some kinds of sheets need further melting and pressuring. Such a sheet is conveyed to the second fixing unit 229b through the sheet conveyance path 312 after passing through the first fixing unit 229a. Then, the sheet is subjected to the melting and pressuring again and is conveyed through a sheet conveyance path 314 to the conveyance path 315. When an image forming mode is a double side mode, the sheet is conveyed to a sheet inversion path 316 and is inverted. After the inversion, the sheet is conveyed to a double-side conveyance path 317, and an image of the second side is transferred to the sheet at the secondary transfer position 309. Then, the printed sheet in which the image has been formed on the sheet is conveyed to the inserter 108.

The inserter 108 has an inserter tray 321 and feeds a sheet (printed sheet) from the inserter tray 321 through a sheet conveyance path 322 so as to join the sheet to the conveyance path. Thereby, the inserter 108 can insert a sheet in an arbitrary position of a series of sheet group conveyed from the printer 107 and can convey the sheet group to the following device. The sheet passing through the inserter 108 is conveyed to the verification apparatus 109. Cameras 331 and 332 are arranged in the verification apparatus 109 so as to face each other. The cameras 331 and 332 are image pickup devices that respectively read a top face and a bottom face of a sheet and correspond to the image pickup unit 240 in FIG. 2. The verification apparatus 109 reads the images of the sheet with the cameras 331 and 332 at a timing when the sheet conveyed through a sheet conveyance path 333 arrives at a predetermined position, and determines whether the images of the sheet are normal. A result of the verification of the sheet (printed sheet) by the verification apparatus 109 is displayed on the operation unit 241 as a verification result. The verification apparatus 109 manages a verification mode as an operational mode. The verification mode is information determining whether the verification apparatus 109 verifies a printed sheet. The verification mode is prescribed by a value of ON or OFF. When the verification mode is set to ON, the verification apparatus 109 reads an image printed on a printed sheet and verifies the printed sheet by determining whether the image is normal or defective. In the meantime, when the verification mode is set to OFF, the verification apparatus 109 does not verify a printed sheet. In this case, the sheet passes through the verification apparatus 109 and is conveyed to the following device. The details of the verification mode will be mentioned later.

The large-capacity stacker 110 has a stack tray 341 as a tray stacking sheets. The sheet (printed sheet) that passes through the verification apparatus 109 is conveyed to the large-capacity stacker 110 through a sheet conveyance path 344. The sheet is stacked on the stack tray 341 while being flipped from the sheet conveyance path 344 through a sheet conveyance path 345. The stack tray 341 has a lifting tray 342 and an ejection tray 343. Moreover, the large-capacity stacker 110 has an escape tray 346 as a discharge tray.

The escape tray 346 is the discharge tray used in order to discharge a sheet (printed sheet) determined as a defective product by the verification apparatus 109. When a sheet is discharged to the escape tray 346, the sheet is conveyed from the sheet conveyance path 344 to the escape tray 346 through a sheet conveyance path 347. When a sheet is conveyed to the finisher 111 of the latter part of the large-capacity stacker 110, the sheet is conveyed through a sheet conveyance path 348. An inversion section 349 inverts a sheet. The inversion section 349 is used when a discharge destination of a sheet is switched corresponding to the determination result of the verification apparatus 109. This aims to gain time needed to verify a sheet by the verification apparatus 109 by reading images on the sheet with the cameras 331 and 332 and to switch the discharge destination among the sheet conveyance paths 345, 347, and 348. When the verification apparatus 109 does not verify a sheet, the inversion section 349 is used only when the sheet is stacked on the stack tray 341 while flipping the sheet.

The finisher 111 has finishing functions, such as stapling (one-place binding or two-place binding), punching (two holes or three holes), and saddle stitch bookbinding. The functions of the finisher 111 are not limited to these functions. The finisher 111 has discharge trays 361 and 362. A sheet (printed sheet) is discharged to the discharge tray 361 through a sheet conveyance path 363. However, the finishing process, such as the stapling process, is not performed in the sheet conveyance path 363. When the finishing process, such as the stapling process, is performed, a sheet is conveyed to a processing unit 365 through a sheet conveyance path 364, and the processing unit 365 performs the finishing function designated by a user. Then, the sheet to which the finishing process has been applied is discharged to the discharge tray 362. The discharge trays 361 and 362 can be moved up and down, respectively. The sheet to which the processing unit 365 applies the finishing process can be stacked on the discharge tray 361 by moving down the discharge tray 361. When the saddle stitch bookbinding is designated, a saddle stitch processing unit 366 applies the stapling process to a center of a sheet and folds the sheet into two. Then, the folded sheet is discharged to a saddle stitch bookbinding tray 368 from a sheet conveyance path 367. The saddle stitch bookbinding tray 368 has a conveyor belt, and a saddle stitch bookbinding bundle stacked on the saddle stitch bookbinding tray 368 is conveyed to a side opposite to the side at which the large-capacity stacker 110 is connected.

Next, screen examples displayed on the operation unit 241 of the verification apparatus 109 will be described. The CPU 238 of the verification apparatus 109 controls the screen displayed on the operation unit 241. As mentioned above, the verification apparatus 109 verifies images of a sent printed sheet according to predetermined verification items. An image of a printed sheet is verified by comparing a correct answer image registered beforehand with the image of the sent printed sheet. Arbitrary image comparison methods, such as a method of comparing pixel values for every image point, a comparison of positions of objects detected by edge detection, and extraction of character data by OCR (Optical Character Recognition), are applicable. Verification items include deviation of a print position, a color tone of an image, density of an image, a streak, thin printing, print omission, etc.

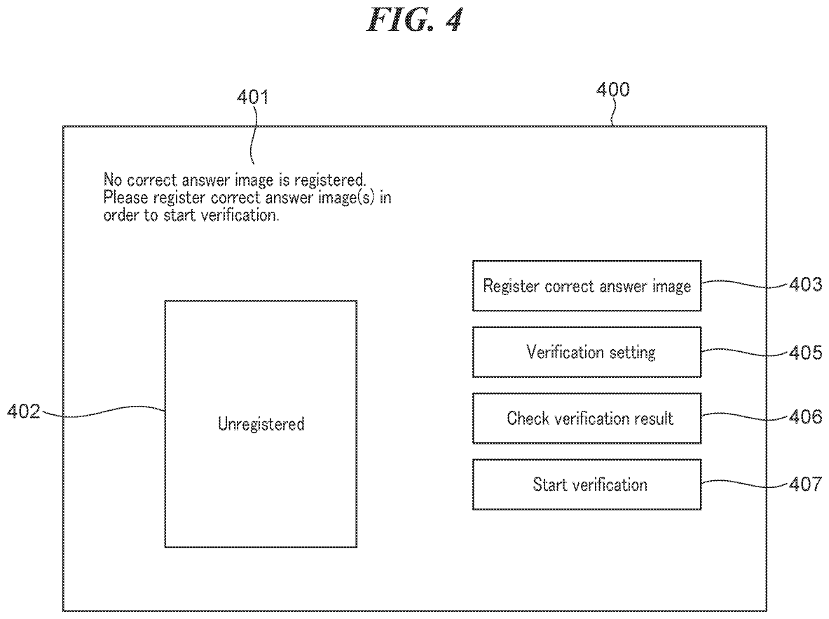

FIG. 4 is a view showing an example of a screen displayed when the verification apparatus 109 is started. The following screens are displayed on the operation unit 241 of the verification apparatus 109 under the control of the CPU 238. When no correct answer image is registered to the verification apparatus 109, the CPU 238 displays a message 401 that requests registration of the correct answer image(s) as shown in FIG. 4 on the operation unit 241. When a correct answer image is registered to the verification apparatus 109, the message 401 is not displayed. The CPU 238 may display a message, which shows that the registration of the correct answer image(s) has been completed and the verification can be started, on the operation unit 241 instead of the message 401. A correct answer image is displayed in an area 402. When no correct answer image is registered, the CPU 238 displays a message of “Unregistered” in the area 402.

A button 403 is used for calling a registration screen of a correct answer image. A correct answer image is a criterion of determination of whether an image read by the verification apparatus 109 is normal or defective. An image that is normally printed on a printed sheet and is read by the verification apparatus 109 is used as a correct answer image, for example. An image that is beforehand checked by visual observation may be used as a correct answer image. A correct answer image is registered by storing into the memory 239 etc., for example. A button 405 is used to call a setting screen about verification. On the setting screen, a user can set the verification items, verification accuracy, etc. depending on a user's verification purpose. The verification accuracy prescribes a degree of difference between a read image and a correct answer image when a printed sheet of a verification target is determined as a defective product. A button 406 is used to call a checking screen of a verification result. When the button 406 is pressed, past verification contents and verification results can be checked. A button 407 is used to instruct start of verification. When the button 407 is pressed, the CPU 238 starts verification of an image of a sent printed sheet. Moreover, when the verification start button 407 is pressed, the CPU 238 sets the verification mode to ON. When the verification is completed, the CPU 238 sets the verification mode to OFF. A button for instructing termination of verification may be provided in the screen 400. For example, when a user manually presses the button for instructing the termination of verification, the CPU 238 sets the verification mode to OFF.

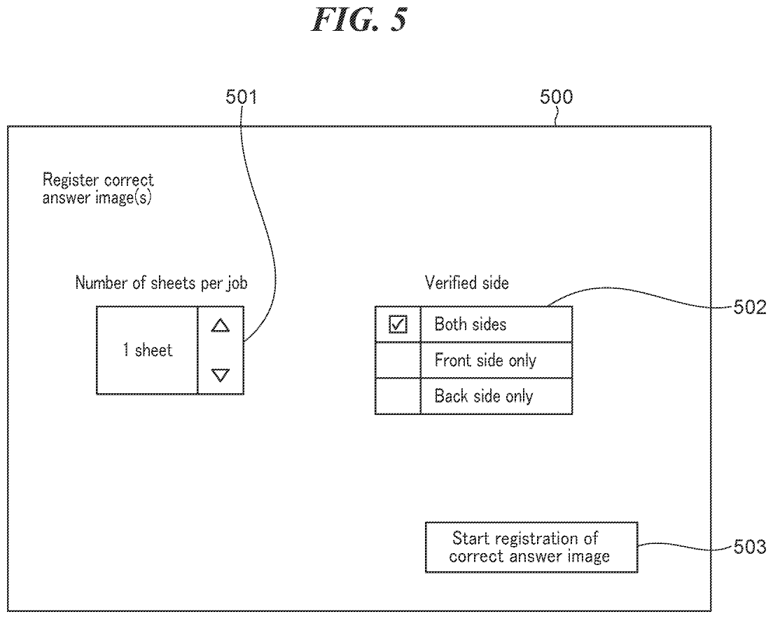

FIG. 5 is a view showing an example of a screen displayed when a correct answer image is registered. The screen 500 in FIG. 5 is displayed when the button 403 in FIG. 4 is pressed. In a setting area 501, the number of sheets per copy of a job to be verified can be set up. When the job includes two or more sheets per copy, a plurality of images are registered to the verification apparatus 109 as the correct answer images. A target side of the verification can be set up in a setting area 502. In the setting area 502 in FIG. 5, a user can select a target side of verification from among “Both sides”, “Front side only”, and “Back side only”. For example, even when an image is printed on one side of a printed sheet, the verification of both sides may be set to check whether dust does not adhere to the side to which no image is printed. A button 503 is used to instruct registration of a correct answer image. When the button 503 is pressed, the CPU 238 controls to read an image of a sent printed sheet and to register the read image as a correct answer image.

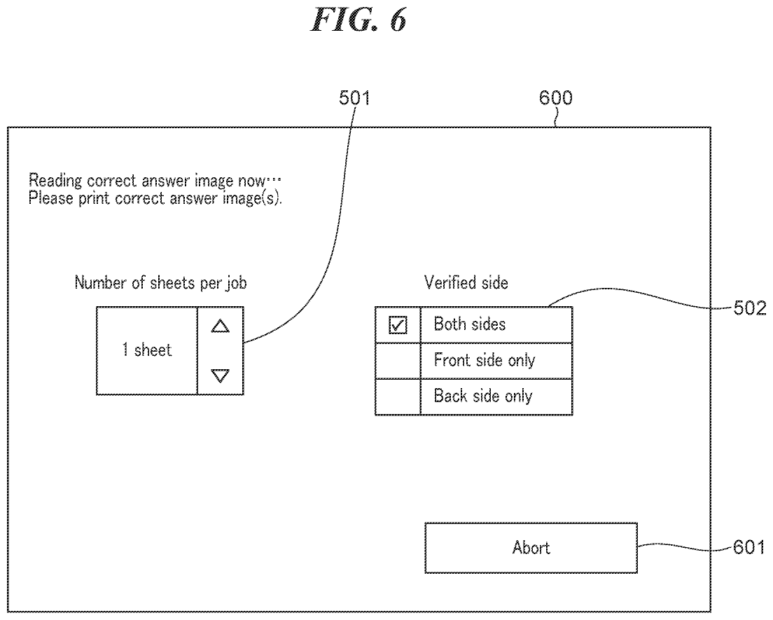

FIG. 6 is a view showing an example of a screen displayed when the correct answer image is being read. When the button 503 in FIG. 5 is pressed, the screen 600 in FIG. 6 is displayed. The screen 500 is displayed until completing the reading of the sheets of the number set up in the setting area 501. A button 601 is used to instruct stop of the reading of the correct answer image. When the button 601 is pressed, the CPU 238 controls to display the screen 400 in FIG. 4 without registering a correct answer image.

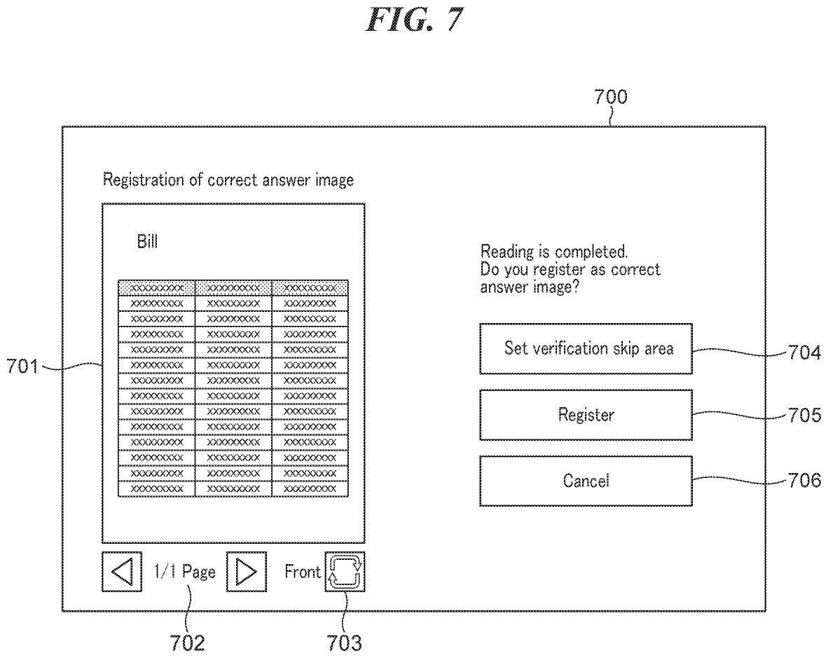

FIG. 7 is a view showing an example of a screen displayed after completing the reading of the correct answer image(s). The image of the printed sheet that is read by the verification apparatus 109 is displayed in an image display area 701. An image switching section 702 is used to switch an image displayed in the image display area 701 among images of a plurality of sheets and includes a previous button, a next button, and a page number. A button 703 is used to switch the front side and the back side when both (front and back) sides of the printed sheet are read. A button 704 is used to instruct the setting of a verification skip area. In this embodiment, an area that is not verified can be set to a case where a print content in a specific area is different in each sheet like a case of Variable Data Printing (VDP). The area that is not verified is the verification skip area. The button 704 can also be used in a case where a printed sheet of which an ID is different in each sheet and a case where a name and an address are different in each sheet.

A button 705 is used to instruct registration of the read image displayed in the image display area 701 as a correct answer image. When the button 705 is pressed, the CPU 238 controls to register the correct answer image and to display the screen 400 in FIG. 4 on the operation unit 241. A button 706 is used to cancel reading of an image. When the button 706 is pressed, the CPU 238 controls to display the screen 400 in FIG. 4 on the operation unit 241 without registering a correct answer image.

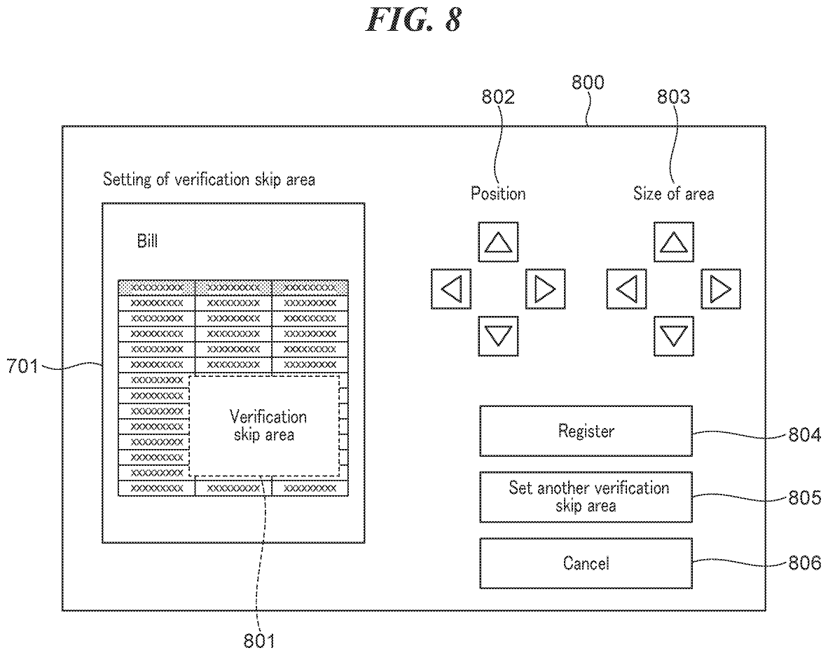

FIG. 8 is a view showing an example of a setting screen of the verification skip area. The screen 800 in FIG. 8 is displayed when the button 704 in FIG. 7 is pressed. An area 801 shows the verification skip area. An area position designation section 802 is provided to designate a position of the verification skip area in the image display area 701 and includes four direction buttons that allow designating an arbitrary position. An area sizes designation section 803 is provided to designate a size of the verification skip area in the image display area 701 and includes four direction buttons that allow enlarging or reducing the area to an arbitrary size. A button 804 is used to register the setting of the verification skip area. When the button 804 is pressed, the CPU 238 controls to register the verification skip area and to display the screen 700 in FIG. 7 on the operation unit 241. A button 805 is used to register the verification skip area and also to register another verification skip area. A plurality of verification skip areas can be registered to the verification apparatus 109. A plurality of verification skip areas can be registered using the button 805. A button 806 is used to cancel the setting of the verification skip area. When the button 806 is pressed, the CPU 238 controls to display the screen 700 in FIG. 7 on the operation unit 241 without registering a verification skip area.

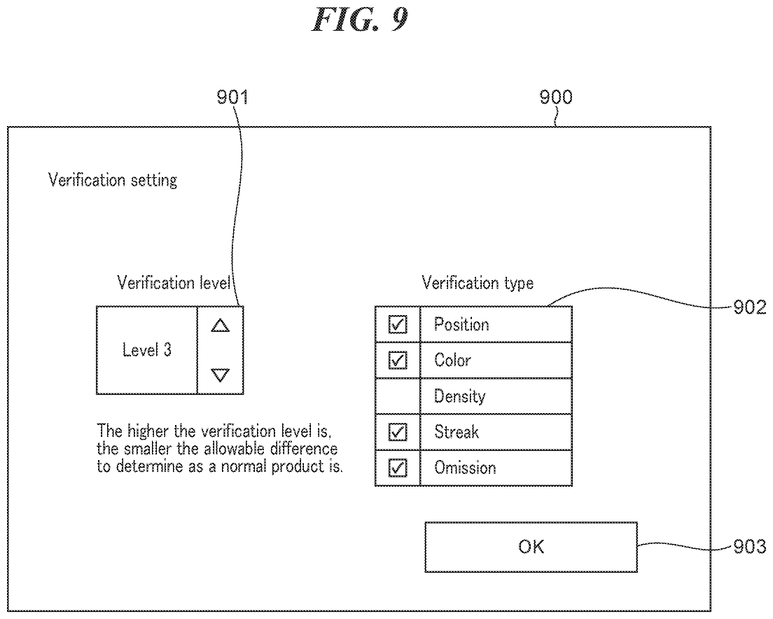

FIG. 9 is a view showing an example of a screen displayed when verification parameters are set up. The screen 900 in FIG. 9 is displayed when the button 405 in FIG. 4 is pressed. A setting area 901 is provided to set up a verification level. The verification accuracy can be arbitrarily changed by changing the verification level in the setting area 901. In this embodiment, the CPU 238 reduces allowable difference (difference between a read image and a correct answer image) that is used to determine that a verification result is normal as the verification level set in the setting area 901 increases. For example, when the verification level is high, the CPU 238 may determine that a printed sheet is a defective product even if difference between a read image and a correct answer image is small. In the meantime, when the verification level is low, the CPU 238 may determine that a printed sheet is a normal product even if difference between a read image and a correct answer image which were read is large. A setting area 902 is provided to set up verification items. The verification items in the setting unit 902 can be set up depending on a verification purpose. In the example in FIG. 9, the print position, color tone, streak, and print omission are included in the verification targets and the density is excluded from the verification targets in the setting area 902. When an OK button 903 is pressed, the CPU 238 controls to display the screen 400 in FIG. 4 on the operation unit 241.

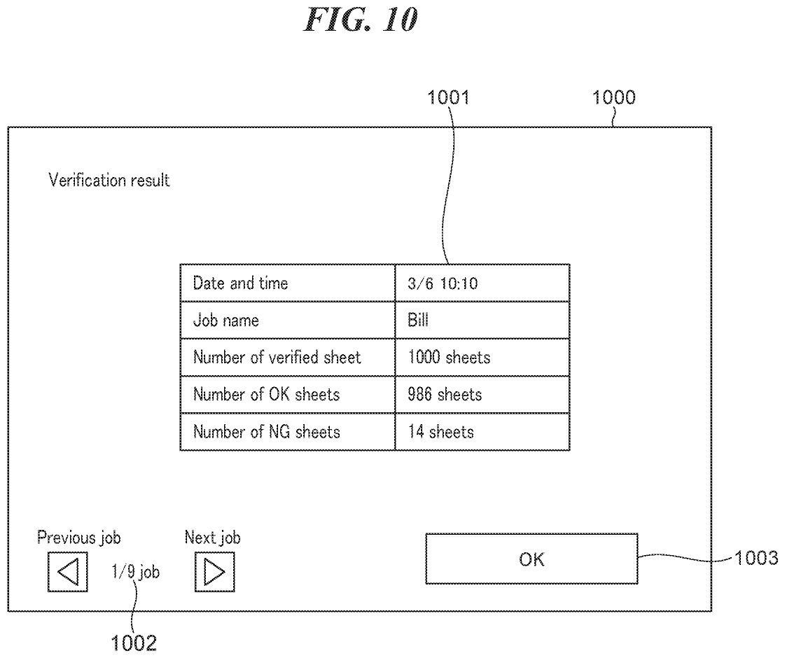

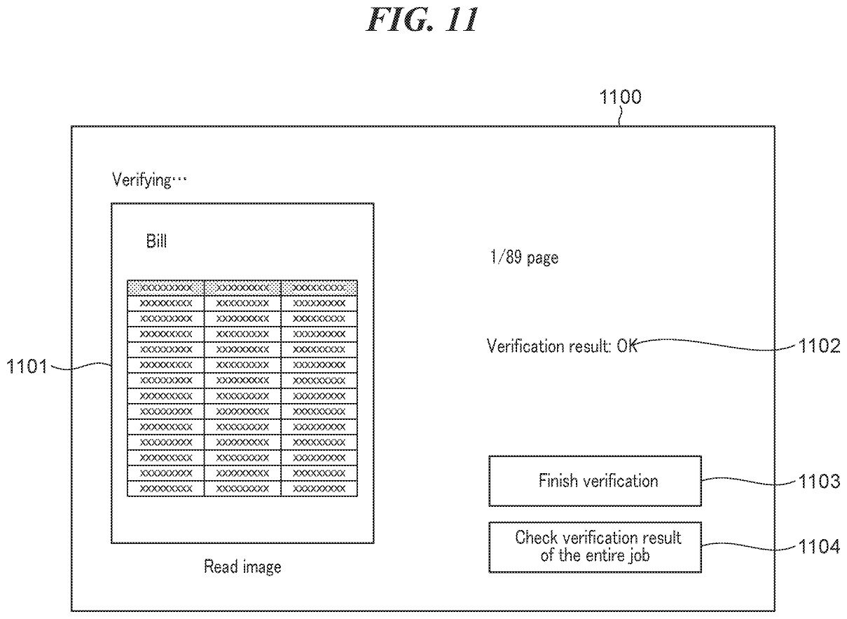

FIG. 10 is a view showing an example of a screen on which a verification result is shown. The screen 1000 in FIG. 10 is displayed when the button 406 in FIG. 4 is pressed. Attributes, verification results, etc. of the verified job are displayed in a result display area 1001. A job selection section 1002 is provided to select a job of which the verification result is displayed. In the result display area 1001, the number of OK sheets shows the number of the printed sheets determined as normal products and the number of NG sheets shows the number of the printed sheets determined as defective products. The example in FIG. 10 shows that the first job is selected from among nine jobs of which histories are saved. The verification results of the printed sheets of the first job are displayed in FIG. 10. The job selection section 1002 includes a previous button, a next button, and a job number. The two buttons are used to select a job. The display contents are switched to verification results of an arbitrary job using the two buttons concerned. A button 1003 is used to finish the display of the screen 1000. When the button 1003 is pressed, the CPU 238 controls to display the screen 400 in FIG. 4 on the operation unit 241.

FIG. 11 is a view showing an example of a screen displayed after starting the verification. The screen 1100 in FIG. 11 is displayed when the button 407 in FIG. 4 is pressed. An image of the printed sheet that is finally read by the verification apparatus 109 is displayed in an area 1101. The verification result that the CPU 238 determined is displayed in a result display area 1102. For example, “OK” is displayed in the result display area 1102 when the verification result is determined as a normal product, and “NG” is displayed when the verification result is determined as a defective product. A button 1103 is used to instruct a finish of the verification. When the button 1103 is pressed, the CPU 238 controls to finish the process concerning the verification and to display the screen 400 in FIG. 4 on the operation unit 241. A button 1104 is used to designate to display a checking screen of the verification results of the entire job. When the button 1104 is pressed, the CPU 238 controls to display the screen 1100 in FIG. 10 that shows the verification results on the operation unit 241.

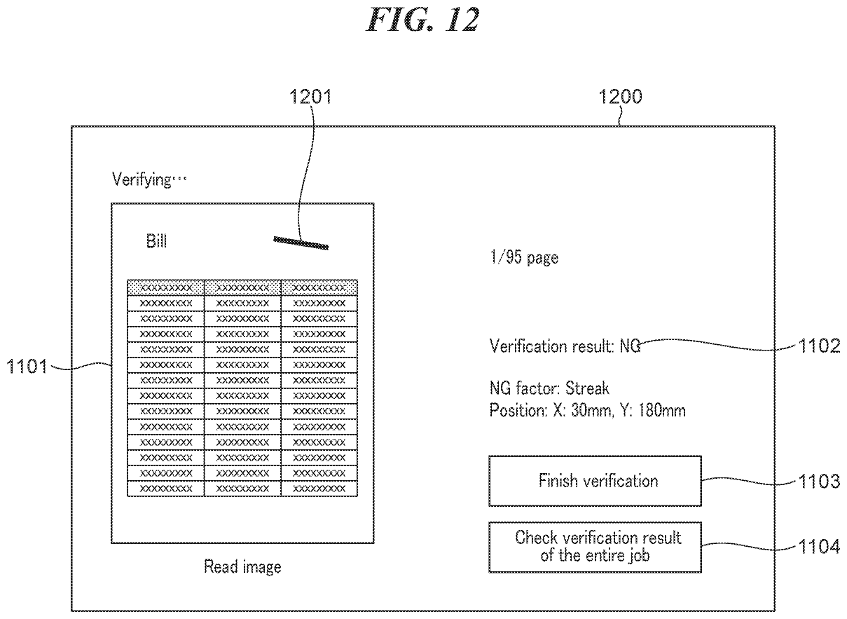

FIG. 12 is a view showing another example of a screen after starting the verification. When an image of a read printed sheet includes defective pixels, the CPU 238 determines whether a verification result means a defective product by referring to the verification level. The image of the printed sheet that is finally read is displayed in the area 1101 in the screen in FIG. 12. The screen in FIG. 11 shows that the verification result of the first page among 89 pages is determined as a normal product. The screen in FIG. 12 shows that the verification result of the first page among 95 pages is determined as a defective product. In the result display area 1102 in FIG. 12, “NG” showing that the verification result is determined as the defective product is displayed. Moreover, the factor of determination as the defective product and the position of the defective pixels are shown in the result display area 1102 in FIG. 12. A streak 1201 is detected in the image of the read printed sheet in the case in FIG. 12. The CPU 238 determines the verification result as the defective product resulting from the streak 1201.

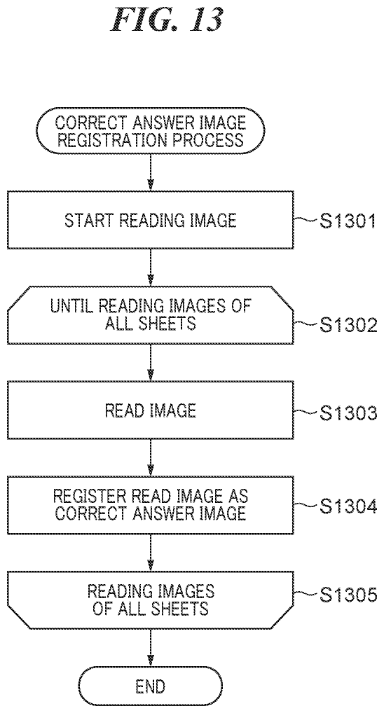

FIG. 13 is a flowchart showing an example of a flow of a process that is executed when registering the correct answer image(s). The process of the flowchart in FIG. 13 is started when the button 403 to register the correct answer image(s) is pressed while displaying the screen 400 in FIG. 4. When receiving a press operation of the button 403, the CPU 238 controls to start reading an image of a printed sheet.

In S1302, the CPU 238 starts reading the printed sheets to register the correct answer images. The process in S1302 is started when there is a sheet of which an image is read. For example, the CPU 238 may determine whether there is a printed sheet of which an image is read on the basis of whether the inserter 108 discharged a printed sheet. The CPU 238 may determine whether there is a sheet of which an image is read on the basis of whether a sensor, which is arranged on the sheet conveyance path at the side of the inserter 108 than the cameras 331 and 332, detects a sheet. The CPU 238 may determine whether there is a sheet of which an image is read on the basis of whether the cameras 331 and 332 detect the sheet.

In S1303, the CPU 238 controls the cameras 331 and 332 to read the images of the printed sheet that is conveyed along the sheet conveyance path 333. Then, the CPU 238 obtains the images that are read by the cameras 331 and 332. In S1304, the CPU 238 registers the correct answer images by storing the read images as the correct answer images into the memory 239. At this time, the CPU 238 displays the image stored into the memory 239 in the image display area 701 of the screen 700 in FIG. 7. In S1305, the CPU 238 repeats the processes in S1302 through S1305 until reading images of all the sheets used to register the correct answer images. After the images of all the sheets used to register the correct answer images have been read, the CPU 238 finishes the process of the flowchart in FIG. 13.

The process for registering the correct answer images is not limited to the process of the flowchart in FIG. 13. For example, the instruction to start reading images may be automatically issued in conjunction with an instruction to start printing in the printer 107, the client terminal 103, or the external controller 102. Moreover, the verification apparatus 109 may capture a plurality of images for the same page and may register an image obtained by combining the captured image as a correct answer image.

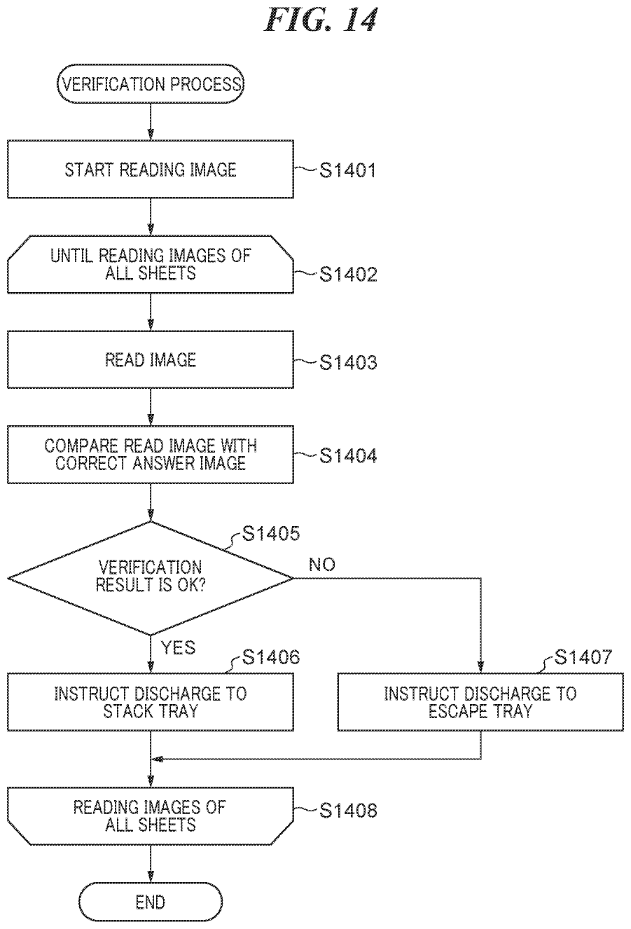

FIG. 14 is a flowchart showing an example of a flow of a verification process that the verification apparatus 109 executes. The process of the flowchart in FIG. 14 is started when the CPU 238 receives a press operation of the button 407 in FIG. 4. In S1401, the CPU 238 controls to start reading an image of a printed sheet (sheet) to be verified. In S1402, reading of an image of a verification target sheet is started. The process in S1402 is started when there is a sheet of which an image is read. This point is the same as that in S1302. In S1403, the CPU 238 controls the cameras 331 and 332 so as to read images of the verification target sheet. Then, the CPU 238 obtains the images that are read by the cameras 331 and 332.

In S1404, the CPU 238 obtains the correct answer image stored in the memory 239 and compares the obtained correct answer image with a verification target image read in S1403. At this time, the CPU 238 aligns the correct answer image and the verification target image. For example, the CPU 238 may align the correct answer image with the verification target image with characteristic points of the correct answer image and the verification target image as reference points of the alignment. Then, the CPU 238 analyzes four corners of the sheet and the above-mentioned reference point in the verification target image and detects whether there is any positional deviation of the image to the sheet. After that, the CPU 238 compares density values of the correct answer image and the verification target image for every pixel and detects a pixel defect on the basis of a comparison result. It should be noted that a method of comparing a correct answer image with a verification target image is not limited to the above-mentioned example.

In S1405, the CPU 238 determines whether the verification result means a normal product (OK) on the basis of the verification level and the detected pixel defect. The pixel defect shows difference between the correct answer image and the verification target image. The higher the verification level is, the smaller the allowable difference to determine as a normal product is. The lower the verification level is, the larger the allowable difference to determine as a normal product is. When the determination result in S1405 is Yes (i.e., when the verification result means the normal product), the CPU 238 proceeds with the flow to S1406. In S1406, the CPU 238 instructs the large-capacity stacker 110 through the communication cable 254 to discharge the sheet to the stack tray 341. In the meantime, when the determination result in S1405 is No (i.e., when the verification result means the defective product), the CPU 238 proceeds with the flow to S1407. In S1407, the CPU 238 instructs the large-capacity stacker 110 through the communication cable 254 to discharge the sheet to the escape tray 346.

After executing the process in S1406 or S1407, the CPU 238 proceeds with the flow to S1408. In S1408, the CPU 238 repeats the processes in S1402 through S1408 until the verifications of all the printed sheets are completed. After the verifications of all the printed sheets are completed, the CPU 238 finishes the process of the flowchart in FIG. 14. The flow of the verification process is not limited to the process of the flowchart in FIG. 14. As mentioned above, an arbitrary method can be employed about the instruction to start reading images. In the process of the flowchart in FIG. 14, the printed sheet of which the verification result is the normal product is discharged to the stack tray 341, and the printed sheet of which the verification result is the defective product is discharged to the escape tray 346. However, a discharge destination may be switched according to a user's instruction or a print setting value.

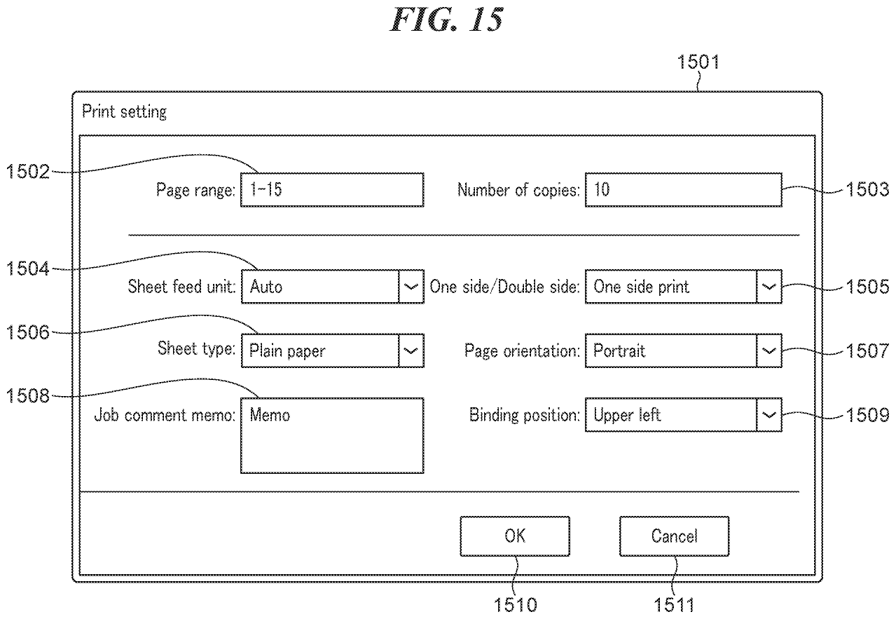

FIG. 15 is a view showing an example of a print setting screen for a job displayed when a correct answer image is registered. Since the above-mentioned screens in FIG. 4 through FIG. 12 are displayed when the verification parameters are set to the verification apparatus 109, these screens are displayed on the operation unit 241 of the verification apparatus 109. In the meantime, the screen 1501 in FIG. 15 is displayed on the display unit 212 of the external controller 102. When the client terminal 103 achieves the function of the external controller 102, the screen 1501 in FIG. 15 is displayed on the display unit 205 of the client terminal 103. For example, the screen for the printer driver installed in the client terminal 103 may be the screen 1501 in FIG. 15.

The screen 1501 includes a text box 1502 in which a page range can be designated. For example, a user can input an arbitrary numerical value into the text box 1502 using the input device 211, such as a mouse and a keyboard. When a numerical value is input into the text box 1502, the CPU 208 recognizes the input numerical value. On the screen 1501, various kinds of print setting items can be set to the page range designated in the text box 1502. In the example in FIG. 15, the various kinds of print setting items include the number of copies, a sheet feed unit, one side/double side, a sheet type, a page orientation, a job comment memo, and a binding position. The print setting items are not limited to the items shown in FIG. 15. Other setting items may be included or some print setting items shown in FIG. 15 may be omitted.

In a text box 1503, the number of copies to be printed within the designated page range can be designated. In a pull-down menu 1504, a user can select a sheet feed unit from which a sheet is fed from among the plurality of sheet feed units 230a and 230b provided in the printer 107. The example in FIG. 15 is set so that a sheet feed unit will be automatically selected. In a pull-down menu 1505, the user can select one-sided printing or double-side printing that will be executed. In a pull-down menu 1506, the user can select the sheet type from among normal paper, thick paper, etc. In a pull-down menu 1507, the user can select a page orientation of a sheet to print from portrait and landscape. In a text box 1508, the user can input a memo (job comment memo) about a job. In a pull-down menu 1509, the user can select a binding position from among upper left, upper right, lower left, lower right, etc. A cancel button 1510 is used to cancel a print setting operation. When the cancel button 1511 is pressed, the CPU 208 cancels the print setting operation and displays the screen that has been displayed prior to displaying the screen 1501.

The screen 1501 may also include an item that sets up a verification mode flag that shows whether the verification will be executed. The verification mode flag can be set to ON or OFF using the item concerned. Details of the verification mode flag will be mentioned later. When the button 1510 is pressed after setting the various kinds of print setting items on the screen 150, the CPU 208 recognizes the print setting values about the job of the time of registering a correct answer image. After that, when the user instructs the verification apparatus 109 to register a correct answer image and issues the print instruction of the job to which the above-mentioned print setting values are set up to the external controller 102, the registration process of the correct answer image is started. When the registration process of the correct answer image is started, the printer 107 prints the correct answer image on a sheet, and the sheet (printed sheet) to which the correct answer image is printed is conveyed to the verification apparatus 109. Then, the verification apparatus 109 reads the correct answer image printed on the printed sheet and registers the read correct answer image according to the flowchart in FIG. 13.

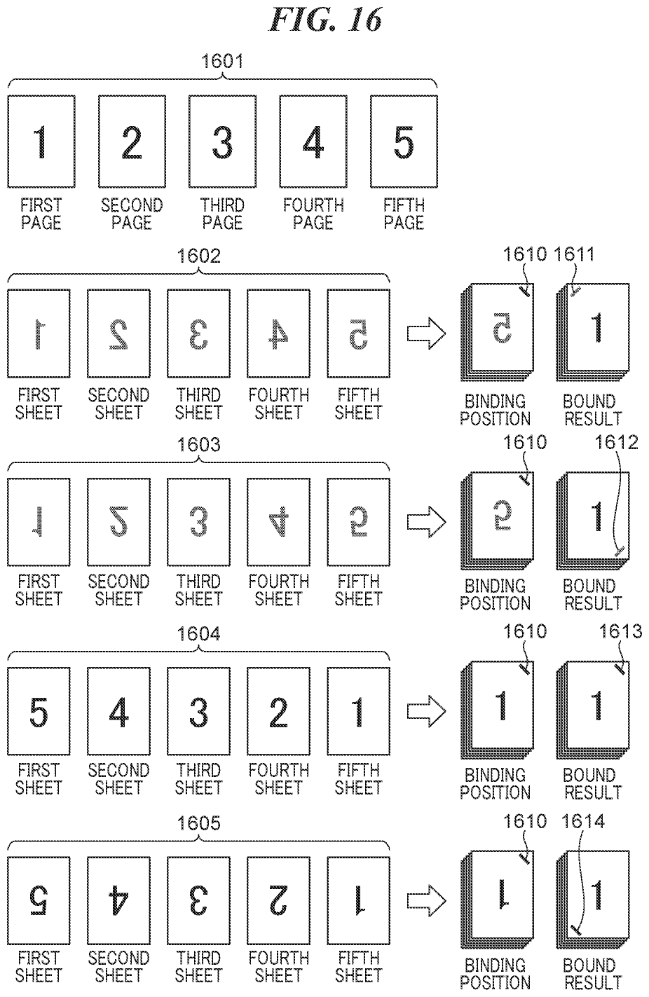

FIG. 16 is a view showing examples of outputs of a job. FIG. 16 shows corresponding relation between print control, a binding process, and a binding result of a case where a sheet bundle is bound by the finisher 111. An image group 1601 shows images “1”, “2”, “3”, “4”, and “5” printed on respective pages. In the meantime, printed sheet groups 1602, 1603, 1604, and 1605 show patterns of the images printed on sheets by the image forming apparatus 101. An orientation of a numerical character expresses an orientation of a printed image on a sheet in the printed sheet groups 1602 through 1605. A deep character shows face-up discharge, and a thin character shows face-down discharge. The face-up discharge means that a sheet is discharged in a state where a front side of a printed face can be seen when the output sheet is viewed from the upper side of the apparatus. The face-down discharge means that a sheet is discharged in a state where a back side of a printed face can be seen when the output sheet is viewed from the upper side of the apparatus (i.e., a state where the front side is downward). In this embodiment, a normal-order printing that sequentially prints a plurality of pages from the first page shall be performed. In this case, the printed sheets are discharged in the face-down discharge in order to conform an output order of the printed sheets. The sheets are stacked in a normal order because the sheets are discharged to the tray from the first page.

A binding position 1610 shows a position to which needle-less binding (needle-less stapling) is applied. A sheet bundle to which the needle-less stapling is applied is bound because parts of sheets are crushed and are mutually bonded by pressure. The binding position 1610 shown in FIG. 16 shows a binding position included in an image sent to the image forming apparatus 101 through the video I/F 215 from the external controller 102. When a process to bind the upper left corners of the printed sheets is performed, the normal-order printing is performed without rotating the orientation of images as shown in the printed sheet group 1602. When the fifth sheet is discharged, the binding process is applied to the binding position 1610 of the sheet bundle. In this case, a bound result position 1611 of the upper left corner of the printed sheet bundle is bound. Moreover, when a process to bind the lower right corners of the printed sheets is performed, the normal-order printing is performed while rotating the orientation of images by 180 degrees (vertical inversion) as shown in the printed sheet group 1603. When the fifth sheet is discharged, the binding process is applied to the binding position 1610 of the sheet bundle. In this case, a bound result position 1612 of the lower right corner of the printed sheet bundle is bound.

Next, when a process to bind the upper right corners of the printed sheets is performed, a reverse-order printing is performed without rotating the orientation of images as shown in the printed sheet group 1604. At the beginning, image data of the fifth page is printed on the first sheet. In this case, a sheet is discharged in the face-up discharge so that the front side of the printed face will be upward. When the printing progresses and the fifth sheet on which the image data of the first page is printed is discharged to the tray, the binding process is applied to the binding position 1610 of the sheet bundle. In this case, a bound result position 1613 of the upper right corner of the printed sheet bundle is bound. Moreover, when a process to bind the lower left corners of the printed sheets is performed, the reverse-order printing is performed while rotating the orientation of images by 180 degrees as shown in the printed sheet group 1605. When the fifth sheet is discharged, the binding process is applied to the binding position 1610 of the sheet bundle. In this case, a bound result position 1614 of the lower left corner of the printed sheet bundle is bound.

As mentioned above, even when the binding position at which the binding process is applied to the printed sheet bundle is the same, the bound result position can be changed by controlling the rotation and output order of the print images. The print setting values by which the orientation and order of images are controlled are not limited to the example mentioned above. For example, the above-mentioned print setting values are applicable to layout control in a saddle stitch bookbinding printing, etc. If a job that prints verification target image is executed while changing the print setting values about the layout control in the saddle stitch bookbinding printing from the print setting values set when a correct answer image is registered, the verification target image cannot be normally compared with the correct answer image. Moreover, when the color tone of the print image is changed, or when the image is enlarged or reduced according to the change of the sheet size, the verification target image cannot be normally compared with the correct answer image. In such a case, it is necessary to redo the process from registration of a correct answer image. Accordingly, in this embodiment, even if the user tries to change the print setting values from the values set when the correct answer image is registered, it is controlled to prohibit changing the print setting values so that the verification target image can be normally compared with the correct answer image.

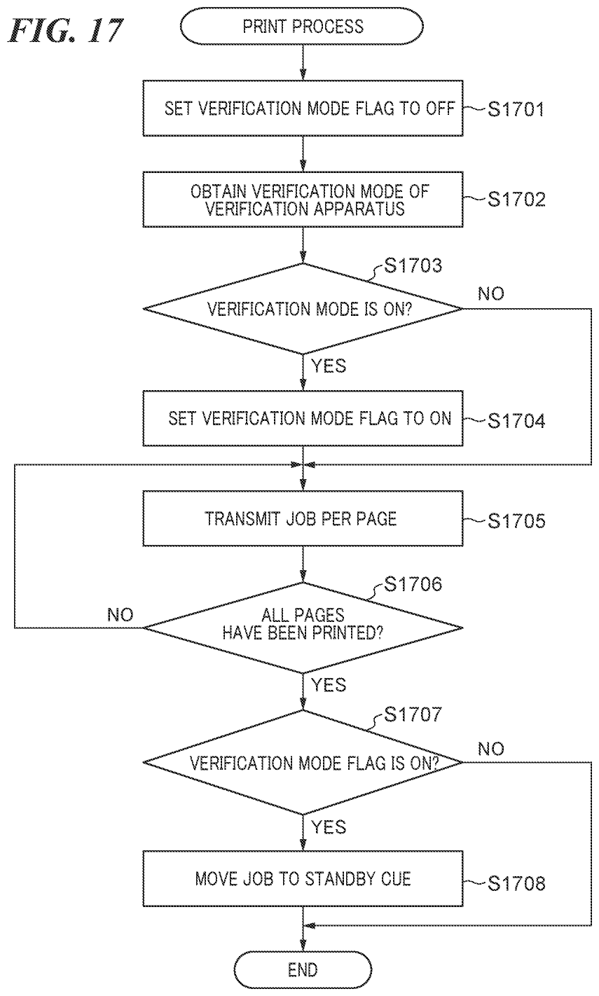

Next, a flow of a process about a print instruction in the external controller 102 will be described. FIG. 17 is a flowchart showing an example of the flow of the process that is executed when the print instruction is issued to the external controller 102. The flowchart in FIG. 17 shows the flow of the process from reception of a print start instruction until completion of the printing. The print start instruction is received after setting to print on a sheet on the print setting screen 1501 in FIG. 15. At the beginning, the verification mode flag is described. The verification mode flag is stored in the HDD 210 in association with a job transmitted to the image forming apparatus 101. Moreover, the verification mode flag is held in the memory 209 from which the program executed by the CPU 208 is read. The verification mode flag is set when the external controller 102 transmits a job to the printer 107 in a mode (hereinafter, referred to as a verification mode ON) in which the verification apparatus 109 reads images on a sheet with the cameras 331 and 332. As mentioned above, the CPU 238 of the verification apparatus 109 may set the verification mode to ON when the button 403 (the registration button for a correct answer image) or the button 407 (the verification start button) in FIG. 4 is pressed.

In S1701, when receiving a print instruction, the CPU 208 sets the verification mode flag to OFF to initialize the verification mode flag. In S1702, the CPU 208 communicates with the CPU 238 of the verification apparatus 109 through the internal LAN 105 before transmitting a job to the image forming apparatus 101 and obtains information about the verification mode of the verification apparatus 109. In S1703, the CPU 208 determines whether the verification mode that the obtained information shows is ON. When the determination result in S1703 is Yes, the CPU 208 proceeds with the flow to S1704. In S1704, the CPU 208 sets the verification mode flag to ON and stores the verification mode flag in the memory 209 in association with a job. When the determination result in S1803 is No, the CPU 208 proceeds with the flow to S1705. In this case, the value of the verification mode flag is not changed from the initial value.

In S1705, the CPU 208 transmits the job based on the print setting values set on the screen 1501 in FIG. 15 to the image forming apparatus 101 per page. The printer 107 of the image forming apparatus 101 prints an image on a sheet according to the received job. In S1706, the CPU 208 determines whether all the pages of the transmitted job have been printed. For example, when the printer 107 of the image forming apparatus 101 completes the print of all the pages of the received job, the printer 107 may transmit information indicating printing completion to the CPU 208 of the external controller 102. The CPU 208 may perform the determination of S1706 on the basis of the received information. When the determination result in S1706 is No, the CPU 208 returns the flow to S1705 because the print of all the pages is not completed. When the determination result in S1706 is Yes, the CPU 208 proceeds with the flow to S1707 because the print of all the pages is completed.

In S1707, the CPU 208 determines whether the verification mode flag is ON by referring to the verification mode flag stored in the memory 209. When the determination result in S1707 is Yes, the CPU 208 moves the job to a standby queue. At this time, the CPU 208 sets the verification mode flag to ON and stores the verification mode flag to the HDD 210 in association with the above-mentioned job. In this case, the HDD 210 functions as the standby queue. The memory 209 may achieve the function of the standby queue. The CPU 208 can call the job stored in the standby queue and can display the information about the job on the display unit 212. After the process in S1708 has been executed or when the determination result in S1707 is No, the CPU 208 finishes the process of the flowchart in FIG. 17. The process of the flowchart in FIG. 17 is applicable to the print for registering a correct answer image and to the print based on a job for verification.

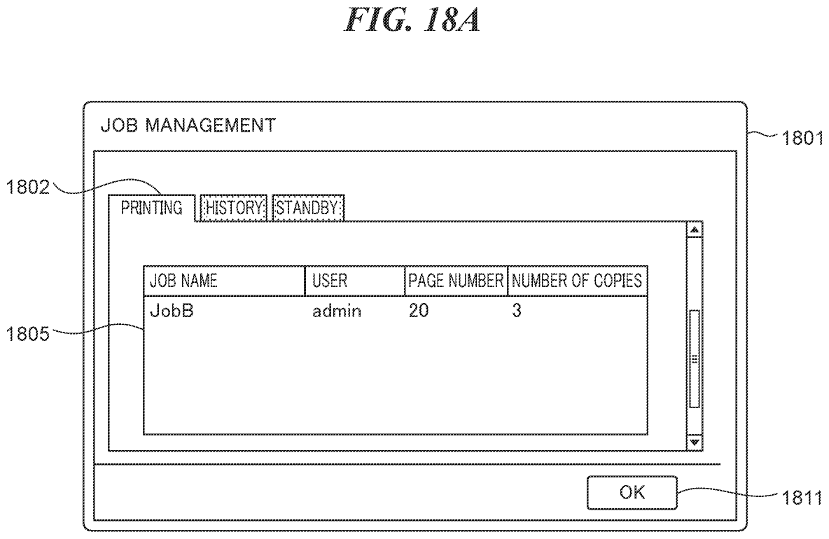

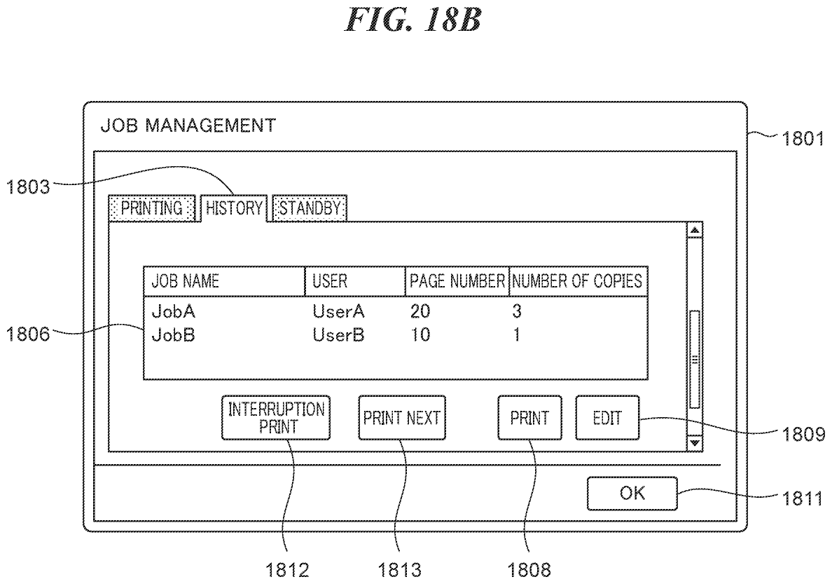

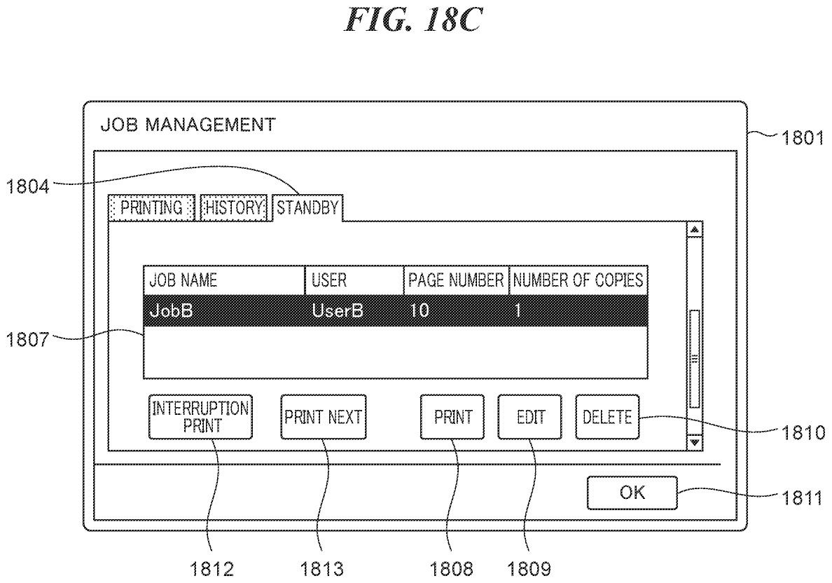

FIG. 18A, FIG. 18B, and FIG. 18C are views showing examples of a job management screen. The screen (job management screen) 1801 in FIG. 18A, FIG. 18B, and FIG. 18C is displayed on the display unit 212 of the external controller 102 under the control of the CPU 208. Various information contents relevant to a job are displayed on the screen 1801. When the information contents relevant to a job have many items, it may be difficult to display all the information contents on the same screen. In such a case, the CPU 208 can switch the displayed information contents using a plurality of tabs like the screen 1801. Moreover, the CPU 208 can shift the screen 1801 to another setting screen. The screen 1801 includes a printing tab that displays a job under printing, a history tab that displays a history of a job printed in the past, and a standby tab that displays a job waited for next print.

The user can operate the tabs of the screen 1801 currently displayed on the display unit 212 using the input device 211 of the external controller 102. The items and the number of tabs included in the screen 1801 are not limited to the examples in FIG. 18A through FIG. 18C. For example, they can be changed depending on the function of the external controller 102 or the image forming apparatus 101. FIG. 18A through FIG. 18C show the contents displayed on the screen 1801 during operations from print start to print end of a job B for registering the correct answer image(s). When receiving a print instruction for registering the correct answer image(s), the CPU 208 starts the process of the flowchart in FIG. 17. When the printing tab 1802 is pressed during the execution of the print process of S1705 in FIG. 17, the CPU 208 displays summary information contents about the job B under printing in a summary information area 1805 as shown in FIG. 18A. The summary information contents in the summary information area 1805 in FIG. 18A include a job name, a user, the number of pages, and the number of copies as print setting items of the job.

When the print is completed, the CPU 208 displays a list of summary information contents about jobs printed in the past in a summary information area 1806 as shown in FIG. 18B. Moreover, when the process of S1708 in FIG. 17 is executed, the CPU 208 displays summary information contents about the job B that has been moved to the standby cue in a summary information area 1807 of the standby tab 1804 as shown in FIG. 18C. The screen 1801 in FIG. 18A through FIG. 18C includes an OK button 1811. When receiving a press operation of the OK button 1811, the CPU 208 hides the screen 1801.

A print button 1808 displayed on the tabs 1803 and 1804 is used to issue the print instruction of a selected job. When the job B is selected in the standby tab 1804, the CPU 208 changes black characters to solid-white characters as shown in FIG. 18C. When the print button 1808 is pressed, the CPU 208 controls to print the selected job with the print setting values that are used in the previous print. When the CPU 208 controls to print the job, the job is transmitted to the image forming apparatus 101, and the image forming apparatus 101 executes the print based on the job. When there is a job under printing, the image forming apparatus 101 will execute the print on the basis of the received job after all the jobs under printing are completed.

The image forming apparatus 101 prints on sheets in the order of the received jobs. However, the external controller 102 can transmit an instruction to execute print jobs in a different order from the order of the jobs that the image forming apparatus 101 received to the image forming apparatus 101. The screen 1801 in FIG. 18B and FIG. 18C includes an interruption print button 1812 and a print-next button 1813. When the interruption print button 1812 is pressed in the state where the job is selected, the CPU 208 transmits a selected interruption job that will be executed preferentially to the image forming apparatus 101. The image forming apparatus 101 processes the received interruption job preferentially rather than other jobs under execution as long as the image forming apparatus 101 allows. For example, the image forming apparatus 101 shall have received two jobs in order of the job A and the job B and that the job A shall be under printing. At this time, when a job C is selected and the interruption print button 1812 is pressed, the CPU 208 transmits an instruction to interrupt the job A that the image forming apparatus 101 is printing by the selected job C to the image forming apparatus 101. The external controller 102 and the image forming apparatus 101 interrupt the job A under printing by the job C to print the job C preferentially.

In this case, the image forming apparatus 101 prints a part of the job A until the interruption first, and then prints the job C, and a remaining part of the job A sequentially. The user can assort the printed sheets of the jobs A and C or can separate the discharge destinations of the printed sheets of the jobs A and C. As mentioned above, the job selected by the interruption print button 1812 can be printed by interrupting the job that the image forming apparatus 101 is printing.

In the meantime, the print-next button 1813 is used to execute a selected job next to the job that the image forming apparatus 101 is executing. When the print-next button 1813 is pressed, the CPU 208 transmits an instruction, which instructs to print the selected job C next to the job that the image forming apparatus 101 is printing, to the image forming apparatus 101. As mentioned above, the image forming apparatus 101 shall have received two jobs in order of the job A and the job B and shall be executing the print of the job A. In this case, when the user presses the print-next button 1813 and the image forming apparatus 101 receives a print instruction of the job C, the image forming apparatus 101 changes the print order in the order of the job A, the job C, and the job B. That is, when the user presses the print-next button 1813, the job C becomes a job that changes the order of jobs that the image forming apparatus 101 executes.

The screen 1801 in FIG. 18B and FIG. 18C includes the print button 1808. The print button 1808 is used to execute print based on a job by the image forming apparatus 101. When the print button 1808 is pressed, the CPU 208 transmits an instruction to execute print of the selected job to the image forming apparatus 101. The job selected by pressing the print button 1808 is neither a job that generates interruption nor a job that changes an order of jobs that the image forming apparatus 101 executes. The job that generates interruption mentioned above can obtain a printed sheet most quickly. The job that changes the order of jobs that the image forming apparatus 101 executes can obtain a printed sheet quickly next.

The screen 1801 shown in FIG. 18B and FIG. 18C includes an edit button 1808. When the edit button 1809 is pressed, the CPU 208 displays the screen 1501 in FIG. 15 on the display unit 212. When a setting value on the screen 1501 is changed, the CPU 208 changes a print setting value according to the changed setting value. A deletion button 1810 shown in FIG. 18C is used to delete a job selected from among jobs of which the summary information contents are displayed in the summary information area 1807 of the standby tab 1804. In the screen examples in FIG. 18A through FIG. 18C, the user who operates the input device 211 in order to register the correct answer image(s) presses the standby tab 1804, selects a job that is subjected to the verification, and can verify the job after setting the number of copies.

The verification apparatus 109 reads the printed sheets that the printer 107 prints according to the job for registering the correct answer images and registers them as the correct answer images. The verification apparatus 109 registers the correct answer images according to the print order set by the job for registering the correct answer images. Moreover, the verification apparatus 109 reads the printed sheets that the printer 107 prints according to the job for verification and verifies them by comparing the read images with the correct answer images. When the job that generates interruption is input from the external controller 102 while the printer 107 is printing by executing the job for verification, the job that the printer 107 is executing is switched to another job. In this case, since the order of the registered correct answer images is in conflict with the order of the images printed under the influence of interruption, correct verification becomes impossible. When the correct answer images are registered by a plurality of jobs and when the print is influenced by a job that changes the order of jobs that the image forming apparatus 101 executes, the order of the registered correct answer images is in conflict with the order of the images of the printed sheets that are printed under the influence of the change of order of the jobs. Accordingly, correct verification becomes impossible. Consequently, the CPU 208 controls as follows.

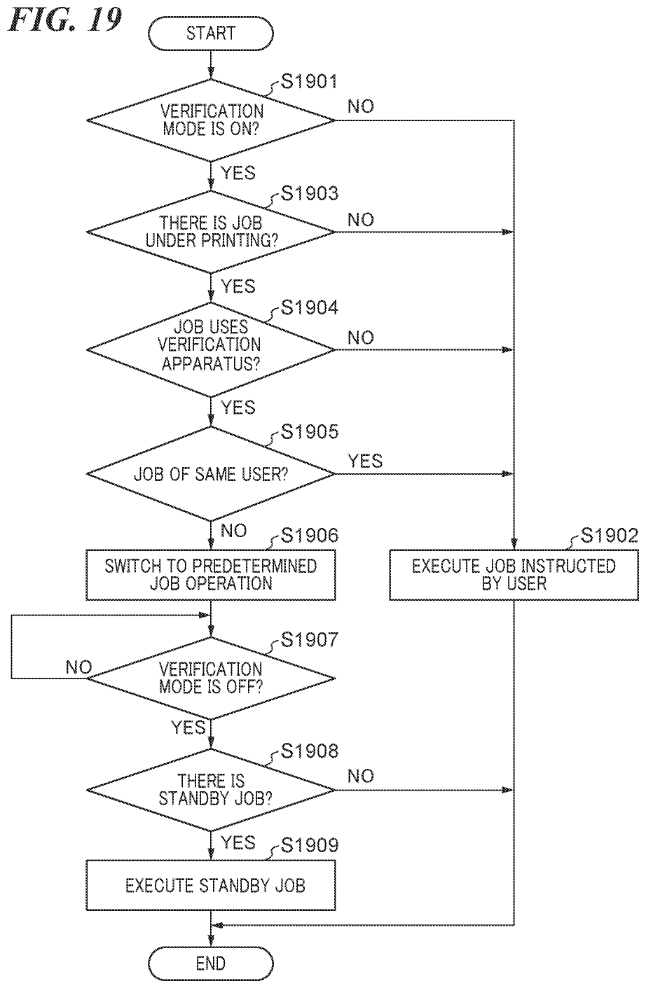

FIG. 19 is a flowchart showing an example of a flow of a process related to the control of a job. The process in FIG. 19 process is started when the print button 1808, the interruption print button 1812, or the print-next button 1813 on the screen 1801 in FIG. 18B or FIG. 18C is pressed. The CPU 208 of the external controller 102 has a function to perform various kinds of control and management while receiving operations of a plurality of jobs simultaneously. When the external controller 102 is operated to print a plurality of jobs, the process of the flowchart in FIG. 19 is executed for each of the jobs. Hereinafter, a job selected in the history tab 1803 in FIG. 18B or the standby tab 1804 in FIG. 18C when the process of the flowchart in FIG. 19 begins shall be a first job.

In S1901, the CPU 208 determines whether the verification mode of the verification apparatus 109 is ON. For example, the CPU 208 may obtain the information about the verification mode from the verification apparatus 109 and may perform the determination in S1901 according to the obtained information. When the determination result in S1901 is No, the CPU 208 proceeds with the flow to S1902. In S1902, the CPU 208 executes the print instruction that the user inputs using the input device 211. The print instruction executed in S1902 is the print instruction that the user designates at the time when this flowchart is started. In the meantime, when the determination result in S1901 is Yes, the CPU 208 proceeds with the flow to S1903. In S1903, the CPU 208 determines whether there is a job that the printer 107 of the image forming apparatus 101 is printing. The CPU 208 may obtain the information about whether there is a job under printing from the verification apparatus 109 and may perform the determination in S1903 according to the obtained information. When the determination result in S1903 is No, the CPU 208 proceeds with the flow to S1902. In the meantime, when the determination result in S1903 is Yes, the CPU 208 proceeds with the flow to S1904.

When the determination result by the CPU 208 in S1901 is No, the interruption of the job mentioned above is not necessary to take into consideration because the verification apparatus 109 does not perform the verification. Moreover, when the determination result by the CPU 208 in S1903 is No, the interruption to the job under printing and the job that changes the print order are not necessary to take into consideration because there is no job that the printer 107 of the image forming apparatus 101 is printing. Accordingly, when the determination result in S1901 is No or when the determination result in S1903 is No, the CPU 208 proceeds with the flow to S1902 and instructs the image forming apparatus 101 to print as designated by the user. The process of S1902 is performed also when the print button 1808 of FIG. 18B and FIG. 18C, the interruption print button 1812, or the print-next button 1813 is pressed. Hereinafter, the job that the printer 107 is printing is called a second job.

In S1904, the CPU 208 determines whether the first job based on the print instruction is a job that passes through the verification apparatus 109. When the determination result in S1904 is No, the CPU 208 proceeds with the flow to S1902. For example, when there is a sheet stacking device or a discharge tray to which printed sheets are discharged at the side of the printer 107 than the verification apparatus 109 in the image forming apparatus 101, the printed sheets that the printer 107 prints are discharged prior to reaching to the verification apparatus 109. The first job as an interruption job that designate print of a color chart for a color tone check shall be input to the image forming apparatus 101 while the printer 107 is printing the second job. Moreover, the first job concerned is set to discharge the printed sheets prior to reaching to the verification apparatus 109. In this case, even when the interruption by the first job is input, the interruption does not affect the print order of the second job because the color chart is discharged prior to reaching to the verification apparatus 109. Accordingly, when the determination result in S1904 is No, the CPU 208 proceeds with the flow to S1902. In the meantime, when the determination result in S1904 is Yes, the CPU 208 proceeds with the flow to S1905.

In S1905, the CPU 208 determines whether the user instructing the print of the first job is the same as the user instructing the print of the second job. A user name (an information content that identifies a user instructing print) is associated with each job in the screen 1801 in FIG. 18A through FIG. 18C. The CPU 208 can perform the determination in S1905 on the basis of the corresponding relation between the job and the user name. When the user instructing the print of the first job is the same as the user instructing the print of the second job, it is estimated that the user intentionally operated to print the first job during the print of the second job. In this case, since the job input to the image forming apparatus 101 is not an unintentional job, the CPU 208 determines Yes in S1905 and proceeds with the flow to S1902.

The CPU 208 may perform the determination in S1905 by a method different from the method that uses the correlation between the job and the user name. For example, the CPU 208 may determine that the jobs are input by the same user when the jobs are received from the same client terminal 103 (terminal). Moreover, the CPU 208 may determine that the jobs are input by the same user when the jobs are generated by operations executed by the same application program on the client terminal 103.

When the determination result in S1905 is No, the CPU 208 proceeds with the flow to S1906. Examples of intentional job operations by the same user will be described. For example, the user shall issue a print instruction of a preceding job X as a second job, which is a verification target, to the external controller 102. After that, the user shall give a press operation (print instruction) to the print button 1808 in order to print a job Y as a first job that is not the verification target. In this situation, the user shall operate the operation unit 241 of the verification apparatus 109 to set the verification mode to OFF when the verification of the printed sheets based on the job X by the verification apparatus 109 progresses to a predetermined stage. For example, in a case where a button for designating a termination of verification is provided in the screen 400, the verification mode becomes OFF when the user presses the button concerned.

In such a case, the print based on the job Y is performed before the print based on the job X finishes. Accordingly, the user who performed the above-mentioned operation can get the printed sheets based on the job Y quickly. At this time, although the print based on the job Y is performed before the print based on the job X finishes, the verification based on an unintentional job is reduced because the user instructing the print of the job X is the same as the user instructing the print of the job Y.

In S1906, the CPU 208 controls to switch the print instruction of the first job to a predetermined job operation. In this embodiment, the predetermined job operation is described as job cancellation or change to a print-start-waiting state that suspends start of print. However, the predetermined job operation may be other operations about a job. The job cancellation is an operation of canceling the job operation performed at the time when the process of the flowchart in FIG. 19 is started. In this case, the summary information contents of the first job remain in the history tab 1803 or the standby tab 1804 in FIG. 18A through FIG. 18C. The CPU 208 displays a warning dialog on the display unit 212 when canceling the job operation.

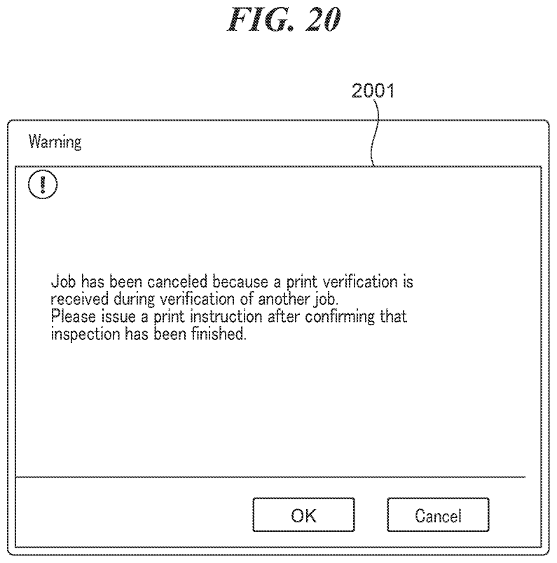

FIG. 20 is a view showing an example of the warning dialog displayed. For example, the warning dialog 2001 is superimposed and displayed on the screen 1801 in FIG. 18A through FIG. 18C. The warning dialog 2001 includes the information showing that the job has been canceled because a print instruction is received during the verification of another job. Although FIG. 20 shows the example of the warning showing that the job has been canceled, the warning showing that the state of the job is changed to the print-start-waiting state that suspends start of print may be displayed. That is, the CPU 208 may control so that the warning showing that the job operation is switched will be displayed on the display unit 212 when the CPU 208 controls to switch the print instruction of the first job to the predetermined job operation in S1906. This can show the user that the instruction of the job has been switched to the predetermined job operation because the print instruction is received during the verification of the other job.

When the state of the job is changed to the print-start-waiting state, the CPU 208 keeps the job of the print-start-waiting state within the external controller 102 without inputting into the printer 107 until a condition of the print start is satisfied. When the condition of the print start is satisfied, the CPU 208 inputs the kept job of the printing-start-waiting state into the printer 107 without needing a user's operation. The condition of the print start will be mentioned later.

In S1907, the CPU 208 determines whether the verification mode of the verification apparatus 109 is OFF. When the determination result in S1907 is No (i.e., when the verification mode is ON), the CPU 208 repeats the determination in S1907 to wait until the verification mode becomes OFF. When the determination result in S1907 is Yes (i.e., when the verification mode becomes OFF), the CPU 208 proceeds with the flow to S1908.

In S1908, the CPU 208 determines whether the first job is in the print-start-waiting state because the print instruction of the first job is switched to the predetermined job operation as mentioned above. When the determination result in S1908 is Yes, the CPU 208 proceeds with the flow to S1909. In S1909, the CPU 208 controls to start the print of the first job that has been in the print-start-waiting state. The condition of the print start is satisfied when the verification mode of the verification apparatus 109 becomes OFF. A condition (predetermined condition) that the verification mode becomes OFF is satisfied when the print of the preceding second job is completed or when the verification mode is set to OFF by the user's operation (when the print of the second job is stopped). When the verification mode becomes OFF, the verification result is not affected even if the print of the first job is started. Accordingly, the print based on the first job is started when reaching the stage where the verification result is not affected.

As described above, when the verification mode of the verification apparatus 109 is ON, the print start of the other job prior to the completion of the verification based on the job for verification is avoidable in this embodiment. This reduces occurrence of an error in a verification result of a printed sheet even if an unexpected job occurs. As a result, occurrence of waste sheets can also be suppressed.

Although the example in which the verification mode is set to the verification apparatus 109 is described in this embodiment, the external controller 102 may set up the verification mode to the verification apparatus 109 on its initiative. In this case, the CPU 208 of the external controller 102 communicates with the CPU 238 of the verification apparatus 109 through the internal LAN 105 and switches the verification mode to ON or OFF. For example, a verification setting item that sets ON or OFF of the verification mode may be provided on a job setting screen like the screen 1501 in FIG. 15. In the verification setting item, ON/OFF of the verification mode can be set for each job.

When receiving the print instruction of the job of which the verification mode is set to ON in the verification setting item, the CPU 208 communicates with the CPU 238 of the verification apparatus 109 and changes the verification mode of the verification apparatus 109 to ON. In this case, the verification mode of the verification apparatus 109 can be set to ON at the timing when the CPU 208 of the external controller 102 receives the print instruction of the job of which the verification mode is set to ON in the verification setting item.

Another user may issue the print instruction between the press of the verification start button 407 in FIG. 4 and the issuance of the print instruction for verification to the external controller 102 by the previous user. In this case, since the job based on the print instruction by the other user no longer corresponds to the job of the correct answer image, the correct verification becomes impossible. Accordingly, the CPU 208 of the external controller 102 sets the verification mode of the verification apparatus 109 to ON at the timing when receiving the print instruction of the job of which the verification mode is set to ON in the verification setting item, as mentioned above. Thereby, the determination result in S1901 in FIG. 19 is Yes. Moreover, when the CPU 208 of the external controller 102 receives a print instruction from a different user, the CPU 208 determines “No” in S1905 and executes the process of S1906. Thereby, the process of S1906 is executed, so that the job operation on the basis of the print instruction from another user is switched to the predetermined job operation. Accordingly, since the job on the basis of the print instruction by other users is not executed, the correct verification becomes available.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-194479, filed Nov. 24, 2020, which is hereby incorporated by reference herein in its entirety.

What is claimed is:

1. A print control apparatus comprising:
a determination unit configured to determine whether a verification apparatus verifies a printed sheet that is printed according to a second job in a case where a print instruction of a first job that is different from the second job is received; and
a controller configured to control to switch the print instruction of the first job to another job operation in the print control apparatus in a case where the determination unit determines that the verification apparatus verifies the printed sheet that is printed according to the second job.

2. The print control apparatus according to claim 1, wherein the first job generates interruption to a job that the printer is executing.

3. The print control apparatus according to claim 1, wherein the first job changes an order of jobs that the printer executes.

4. The print control apparatus according to claim 1, wherein the controller controls whether the print instruction of the first job is switched to the other job operation based on whether the first job is a target process of the verification apparatus.

5. The print control apparatus according to claim 4, wherein the printed sheet that is printed according to the first job is discharged before reaching the verification apparatus.

6. The print control apparatus according to claim 1, wherein the controller controls whether the print instruction of the first job is switched to the other job operation based on whether the first job and the second job are designated by a same user.

7. The print control apparatus according to claim 1, wherein the controller controls whether the print instruction of the first job is switched to the other job operation based on whether the first job and the second job are received from a same terminal.

8. The print control apparatus according to claim 1, wherein the controller controls whether the print instruction of the first job is switched to the other job operation based on whether the first job and the second job are generated by operations executed by a same application program.

9. The print control apparatus according to claim 1, wherein the other job operation cancels the first job.

10. The print control apparatus according to claim 1, wherein the other job operation suspends start of print based on the first job.

11. The print control apparatus according to claim 10, wherein the controller controls to start the print based on the first job of which the start of the print is suspended in a case where a predetermined condition is satisfied.

12. The print control apparatus according to claim 11, wherein the predetermined condition is satisfied in a case where the print based on the second job is completed.

13. The print control apparatus according to claim 11, wherein the predetermined condition is satisfied in a case where the print based on the second job is stopped.

14. The print control apparatus according to claim 1, further comprising a display unit, and
wherein the controller displays warning showing that the print instruction of the first job has been switched to the other job operation due to the first job on the display unit in a case where the first job is changed to the other job operation.

15. The print control apparatus according to claim 1, wherein the controller is able to set information that is managed by the verification apparatus and indicates whether the verification apparatus is verifying a printed sheet.

16. A control method for a print control apparatus, the control method comprising:
determining whether a verification apparatus verifies a printed sheet that is printed according to a second job in a case where a print instruction of a first job that is different from the second job is received; and
controlling to switch the print instruction of the first job to another job operation in the print control apparatus in a case where the determination unit determines that the verification apparatus verifies the printed sheet that is printed according to the second job.

17. A non-transitory computer-readable storage medium storing a control program causing a computer to execute a control method for a print control apparatus, the control method comprising:
determining whether a verification apparatus verifies a printed sheet that is printed according to a second job in a case where a print instruction of a first job that is different from the second job is received; and
controlling to switch the print instruction of the first job to another job operation in the print control apparatus in a case where the determination unit determines that the verification apparatus verifies the printed sheet that is printed according to the second job.
